(19) United States
(12) Patent Application Publication
(10) Pub. No.: US 2020/0338963 A1
(43) Pub. Date: Oct. 29, 2020

(54) COOLING DEVICE

(71) Applicants: TOYOTA JIDOSHA KABUSHIKI KAISHA, Aichi-ken (JP); DENSO CORPORATION, Aichi-pref (JP)

(72) Inventors: Yusuke SUZUKI, Nagakute-shi (JP); Yoshiyuki YAMASHITA, Susono-shi (JP); Takeshi YOSHINORI, Kariya-city (JP); Yasumitsu OMI, Kariya-city (JP); Koji MIURA, Kariya-city (JP)

(21) Appl. No.: 16/852,549

(22) Filed: Apr. 20, 2020

(30) Foreign Application Priority Data
Apr. 26, 2019 (JP) 2019-086778

(51) Int. Cl. B60H 1/32; B60K 11/02; F28D 15/02; H01M 10/613; H01M 10/625; H01M 10/6556; H01M 10/6569

(52) U.S. Cl. CPC B60H 1/32; B60K 11/02; F28D 15/02; H01M 10/6569; H01M 10/625; H01M 10/6556; H01M 10/613

(57) ABSTRACT

A cooling device includes: an evaporator cooling a cooling object by evaporating a heat medium in a liquid phase by a heat exchange between the cooling object and the heat medium; a condenser, disposed above the evaporator, radiating a heat of the heat medium to an external fluid by condensing the heat medium in a gas phase by a heat exchange between the heat medium and the external fluid; a gas-phase passage for guiding the gas-phase heat medium from the evaporator to the condenser; and a liquid-phase passage for guiding the liquid-phase heat medium from the condenser to the evaporator. Further, the gas-phase passage includes a rising portion on one side of the cooling device in a predetermined direction orthogonal to a vertical direction and at least a part of the rising portion rises above surroundings.

### CROSS-REFERENCE TO RELATED APPLICATION(S)

The present application claims priority to and incorporates by reference the entire contents of Japanese Patent Application No. 2019-086778 filed in Japan on Apr. 26, 2019.

### BACKGROUND

The present disclosure relates to a cooling device.

Japanese Patent No. 5942943 B2 discloses a battery temperature control device as a cooling device that cools a battery as a cooling object by boiling and condensation actions of a heat medium as a working fluid. This battery temperature control device includes a heat medium cooling unit as a condensation unit and a temperature control unit as an evaporation unit. The heat medium cooling unit is disposed at a position higher than the temperature control unit and the heat medium in a liquid phase stays in the lower portion of the temperature control unit. Further, the heat medium cooling unit and the temperature control unit are annularly interconnected in a predetermined direction by a liquid-phase passage portion and a gas-phase passage portion formed of a piping member and the battery temperature control device is configured such that the heat medium as a working fluid circulates between the heat medium cooling unit and the temperature control unit. In addition, the temperature control unit is disposed so as to be in contact with side surfaces of a plurality of battery cells constituting a battery pack and cools the battery pack by evaporation of the heat medium. In addition, the temperature control unit is formed so as to extend in the direction in which the plurality of battery cells are arranged. The liquid-phase heat medium from the heat medium cooling unit flows into the temperature control unit through the liquid-phase passage portion from one end of the temperature control unit in the battery cell arrangement direction. Then, the liquid-phase heat medium in the temperature control unit evaporates while flowing to the other end from one end in the battery cell arrangement direction and the heat medium in a gas phase flows out to the gas-phase passage portion from the other end and moves to the heat medium cooling unit through the gas-phase passage portion.

### SUMMARY

There is a need for providing a cooling device, which can suppress the accumulation of the liquid-phase heat medium in the gas-phase passage portion even in a case where one side thereof relatively moves up and down with respect to another side thereof in the predetermined direction.

According to an embodiment, a cooling device includes: an evaporator cooling a cooling object by evaporating a heat medium in a liquid phase by a heat exchange between the cooling object and the heat medium; a condenser, disposed above the evaporator, radiating a heat of the heat medium to an external fluid by condensing the heat medium in a gas phase by a heat exchange between the heat medium and the external fluid; a gas-phase passage for guiding the gas-phase heat medium from the evaporator to the condenser; and a liquid-phase passage for guiding the liquid-phase heat medium from the condenser to the evaporator. Further, the gas-phase passage includes a rising portion on one side of the cooling device in a predetermined direction orthogonal to a vertical direction and at least a part of the rising portion rises above surroundings.

### BRIEF DESCRIPTION OF THE DRAWINGS

FIG. 1 is a diagram illustrating a schematic configuration of a cooling device according to a first embodiment;

FIG. 2 is a perspective view illustrating a schematic configuration of the cooling device according to the first embodiment;

FIG. 3 is a side view illustrating a main portion of the cooling device according to the first embodiment;

FIG. 4 is a diagram illustrating a state where a pair of end plates are provided on both end sides of a battery pack in a vehicle width direction;

FIG. 5 is a diagram illustrating the positional relationship of an evaporator, a heat conduction material, and the battery pack;

FIG. 6 is an exploded perspective view illustrating a schematic configuration of the evaporator;

FIG. 7 is a perspective view schematically illustrating the positional relationship of the battery pack and the flow of a working fluid in the evaporator;

FIG. 8 is a diagram illustrating the interconnection structure of a first gas passage portion, a liquid passage portion, and the evaporator;

FIG. 9 is a perspective view of the evaporator provided with a lower-side fluid inlet portion and a lower-side fluid outlet portion;

FIG. 10 is a diagram illustrating the posture of the cooling device according to the first embodiment during uphill traveling;

FIG. 11 is a diagram illustrating the posture of the cooling device according to the first embodiment during downhill traveling;

FIG. 12 is a side view illustrating a schematic configuration of the cooling device according to a second embodiment;

FIG. 13 is a diagram illustrating the posture of the cooling device according to the second embodiment during uphill traveling;

FIG. 14 is a diagram illustrating the posture of the cooling device according to the second embodiment during downhill traveling;

FIG. 15 is a side view illustrating a schematic configuration of the cooling device according to a third embodiment;

FIG. 16 is a diagram illustrating the posture of the cooling device according to the third embodiment during downhill traveling;

FIG. 17 is a side view illustrating a schematic configuration of the cooling device according to a first modification example of the third embodiment;

FIG. 18 is a side view illustrating a schematic configuration of the cooling device according to a fourth embodiment;

FIG. 19 is a diagram illustrating the posture of the cooling device according to the fourth embodiment during downhill traveling;

FIG. 20 is a side view illustrating a schematic configuration of the cooling device according to a fifth embodiment;

FIG. 21 is a diagram illustrating the posture of the cooling device according to the fifth embodiment during downhill traveling;

FIG. 22 is a side view illustrating a schematic configuration of the cooling device according to a sixth embodiment; and

FIG. 23 is a diagram illustrating the posture of the cooling device according to the sixth embodiment during downhill traveling.

### DETAILED DESCRIPTION OF THE PREFERRED EMBODIMENTS

Although the gas-phase passage portion passes through a position higher than the liquid-phase passage portion in the battery temperature control device disclosed in Japanese Patent No. 5942943 B2, the liquid-phase heat medium may flow into and accumulate in the gas-phase passage portion when the battery temperature control device is inclined, that is, when the other side relatively moves up and down with respect to one side in the predetermined direction. When the liquid-phase heat medium accumulates in the gas-phase passage portion as described above, it may become difficult for the gas-phase heat medium to move from the temperature control unit to the heat medium cooling unit through the gas-phase passage portion.

### First Embodiment

Hereinafter, a first embodiment of a cooling device according to the present disclosure will be described. It should be noted that the present disclosure is not limited by the present embodiment.

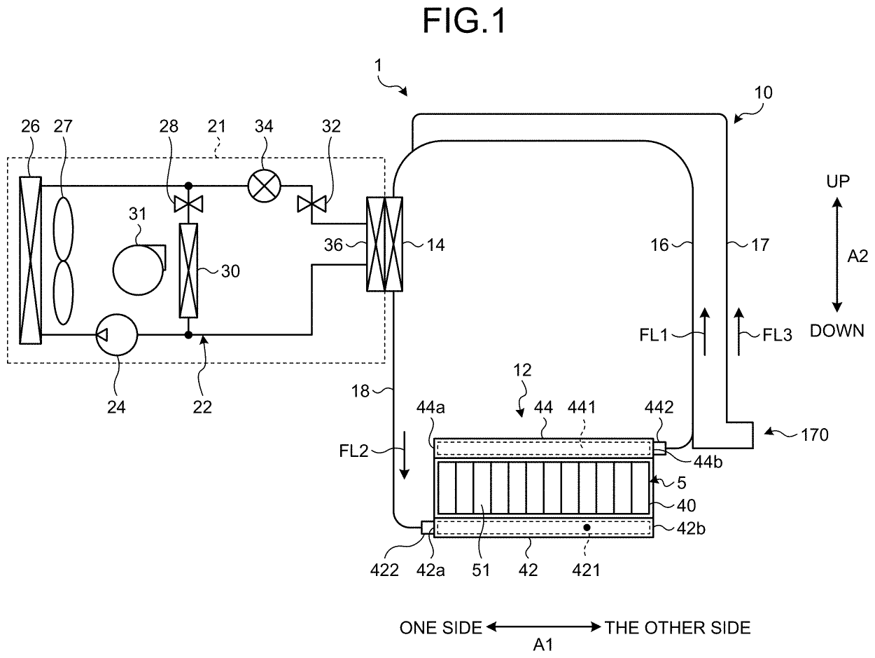

FIG. 1 is a diagram illustrating a schematic configuration of a cooling device 1 according to the first embodiment. The cooling device 1 according to the first embodiment illustrated in FIG. 1 adjusts the battery temperature of a battery pack 5 by cooling the battery pack 5 mounted in a vehicle as a cooling object. Assumed as the vehicle in which the cooling device 1 is mounted is, for example, a hybrid vehicle or an electric vehicle capable of traveling by means of a traveling electric motor (not illustrated) using the battery pack 5 as a power source.

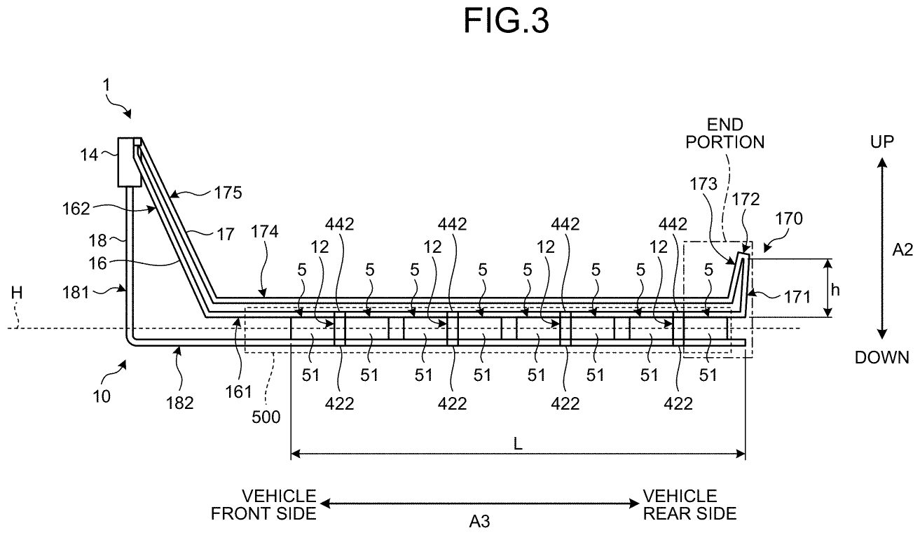

The battery pack 5 has a plurality of battery cells 51 having a rectangular parallelepiped shape. The plurality of battery cells 51 are arranged in a battery cell arrangement direction A1, which is a predetermined arrangement direction. Accordingly, the entire battery pack 5 also has a substantially rectangular parallelepiped shape. Further, the battery pack 5 has, as a part of the surface of the battery pack 5, a battery lower surface 5a (see FIG. 3), which is a downward battery bottom surface, and a battery side surface 5b (see FIG. 3), which extends along a vehicle up-down direction A2. It should be noted that the vehicle up-down direction A2 in the present embodiment coincides with a vertical direction when the vehicle is positioned on a horizontal road surface and the battery cell arrangement direction A1 in the present embodiment is a vehicle width direction, which is a direction intersecting with the vehicle up-down direction A2, more specifically, a direction orthogonal to the vehicle up-down direction A2.

The cooling device 1 includes a working fluid circuit 10 through which a working fluid circulates. A refrigerant (such as R134a and R1234yf) used in a vapor compression-type refrigeration cycle is adopted as the working fluid circulating through the working fluid circuit 10. As illustrated in FIG. 1, the working fluid circuit 10 is configured to include an evaporator 12, a condenser 14, a first gas passage portion 16, a second gas passage portion 17, and a liquid passage portion 18. In other words, the working fluid circuit 10 is a closed annular fluid circuit. A predetermined amount of working fluid is sealed in the inner portion of the working fluid circuit 10 and the inner portion of the working fluid circuit 10 is filled with the working fluid.

The evaporator 12 as an evaporation unit is a heat exchanger that exchanges heat between the working fluid flowing through the evaporator 12 and the battery pack 5. In other words, the evaporator 12 absorbs heat from the battery pack 5 to the working fluid in a liquid phase with the circulation of the working fluid through the working fluid circuit 10, and the working fluid in the liquid phase is evaporated (boiled and vaporized) as a result. The evaporator 12 of the present embodiment is connected to the side of the battery pack 5 so as to be capable of conducting heat. In addition, the evaporator 12 is disposed below the condenser 14. As a result, the working fluid in the liquid phase is accumulated by gravity in the lower portion of the working fluid circuit 10 including the evaporator 12.

The condenser 14 as a condensation unit is a heat exchanger that condenses the gas-phase working fluid evaporated by the evaporator 12. The condenser 14 is disposed in, for example, the engine room of the vehicle and condenses the working fluid by radiating heat from the gas-phase working fluid by heat exchange with the refrigerant that is an external fluid of a refrigeration cycle device 21 for air conditioning mounted in the engine room. In addition, the space in the engine room can be effectively utilized by the condenser 14 being disposed in the engine room of the vehicle. The refrigeration cycle device 21 is a part of a vehicular air conditioning device. The refrigeration cycle device 21 includes a refrigerant circuit 22 through which the refrigerant circulates and flows.

The condenser 14 is thermally connected to a refrigerant-side heat exchanger 36 such that heat can be exchanged between the refrigerant-side heat exchanger 36 through which the refrigerant of the refrigerant circuit 22 flows and the working fluid flowing through the condenser 14.

The refrigerant circuit 22 constitutes the vapor compression-type refrigeration cycle. Specifically, the refrigerant circuit 22 is formed by a compressor 24, an air conditioning condenser 26, a first expansion valve 28, an air conditioning evaporator 30 and the like being connected by piping. The refrigeration cycle device 21 includes a blower 27 sending air to the air conditioning condenser 26 and a blower 31 forming an air flow toward the interior space of the vehicle. For example, the air conditioning condenser 26 and the blower 27 are provided outside the passenger compartment of the vehicle and the blower 27 sends outside air, which is air outside the passenger compartment, to the air conditioning condenser 26.

The compressor 24 compresses and discharges the refrigerant. The air conditioning condenser 26 is a radiator that radiates and condenses the refrigerant flowing out of the compressor 24 by heat exchange with air. The first expansion valve 28 reduces the pressure of the refrigerant flowing out of the air conditioning condenser 26. The air conditioning evaporator 30 evaporates the refrigerant flowing out of the first expansion valve 28 and cools the air heading for the vehicle interior space by heat exchange with the air heading for the vehicle interior space.

Further, the refrigerant circuit 22 has a second expansion valve 32 and the refrigerant-side heat exchanger 36 connected in parallel to the first expansion valve 28 and the air conditioning evaporator 30 by a refrigerant flow. The second expansion valve 32 reduces the pressure of the refrigerant flowing out of the air conditioning condenser 26. The refrigerant-side heat exchanger 36 is a refrigerant evaporation unit that evaporates the refrigerant by heat exchange with the working fluid flowing through the condenser 14.

In addition, the refrigerant circuit 22 has an on-off valve 34 that opens and closes the refrigerant flow path through which the refrigerant flows toward the refrigerant-side heat exchanger 36. A first refrigerant circuit through which the refrigerant flows in the order of the compressor 24, the air conditioning condenser 26, the first expansion valve 28, and the air conditioning evaporator 30 is formed by the on-off valve 34 being closed. By the on-off valve 34 being opened, a second refrigerant circuit through which the refrigerant flows in the order of the compressor 24, the air conditioning condenser 26, the second expansion valve 32, and the refrigerant-side heat exchanger 36 is formed in addition to the first refrigerant circuit.

The on-off valve 34 is appropriately opened and closed in accordance with a predetermined condition, for example, the necessity of cooling the battery pack 5. At least the compressor 24 and the blower 27 operate in a case where the on-off valve 34 is open. As a result, in the condenser 14, the gas-phase working fluid is cooled and condensed by heat exchange with the refrigerant flowing through the refrigerant-side heat exchanger 36.

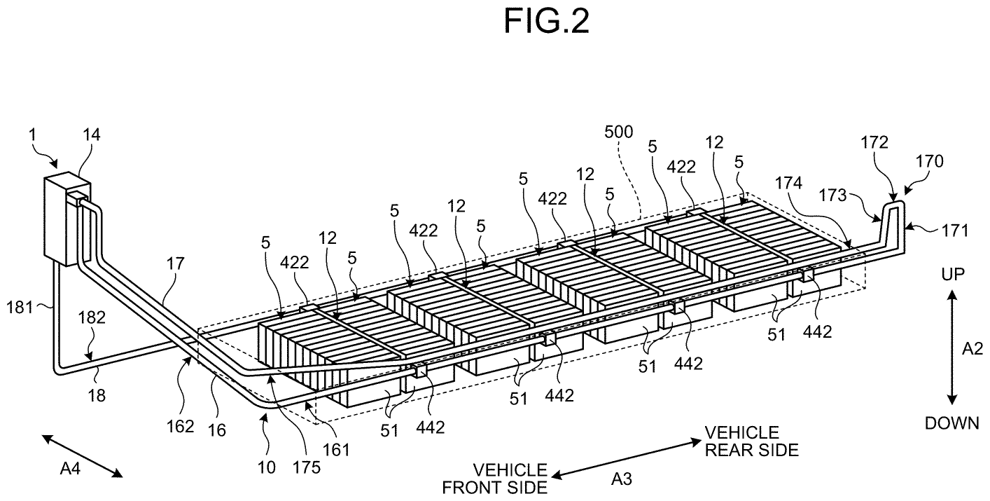

FIG. 2 is a perspective view illustrating a schematic configuration of the cooling device 1 according to the first embodiment. FIG. 3 is a side view illustrating a schematic configuration of the cooling device 1 according to the first embodiment. In the cooling device 1 according to the first embodiment, a vehicle front-rear direction A3 in FIGS. 2 and 3 is a direction orthogonal to the vertical direction when the vehicle is positioned on a horizontal road surface. In other words, in the present embodiment, a predetermined direction in the cooling device 1 that is orthogonal to the vertical direction coincides with the vehicle front-rear direction A3. Further, in the cooling device 1 illustrated in FIGS. 2 and 3, one side in the predetermined direction is the vehicle rear side in the vehicle front-rear direction A3 and the other side in the predetermined direction is the vehicle front side in the vehicle front-rear direction A3. In addition, in the cooling device 1 illustrated in FIGS. 2 and 3, the condenser 14 is positioned on the other side in the predetermined direction, that is, the vehicle front side in the vehicle front-rear direction A3. It should be noted that the reference numeral H in FIGS. 2 and 3 indicates the liquid level of the liquid-phase working fluid in the working fluid circuit 10.

Four evaporators 12 are arranged at predetermined intervals in the vehicle front-rear direction A3 in the cooling device 1. Each of the four evaporators 12 cools the two battery packs 5 that are disposed on the vehicle front side and the vehicle rear side of the evaporator 12 in the vehicle front-rear direction A3. It should be noted that the eight battery packs 5 are disposed side by side in the vehicle front-rear direction A3 with respect to the four evaporators 12 in the first embodiment and the four evaporators 12 and the eight battery packs 5 are integrally accommodated in a battery pack 500, which is an accommodating chamber. The battery pack 500 accommodates the battery packs 5 in a case formed in a container shape and is mounted in, for example, the bottom portion of the vehicle. It should be noted that the accommodating chamber in which the battery packs 5 are accommodated does not necessarily have to be the battery pack using the container-shaped case and may be, for example, an accommodating chamber surrounded by a vehicle frame or panel.

The first gas passage portion 16, which is a first gas-phase passage portion, guides the gas-phase working fluid evaporated by the evaporator 12 to the condenser 14. The first gas passage portion 16 is configured by a first pipe portion 161 and a second pipe portion 162 by means of a piping member or the like. The first pipe portion 161 extends in the vehicle front-rear direction A3. The second pipe portion 162 is inclined at a rising gradient to the vehicle front side when viewed from the vehicle rear side in the vehicle front-rear direction A3 and extends in the vehicle up-down direction A2.

Respective fluid outlet portions 442 of three evaporators 12 are connected to the first pipe portion 161. The end portion of the first pipe portion 161 that is on the vehicle front side in the vehicle front-rear direction A3 is connected to the lower-side end portion of the second pipe portion 162 in the vehicle up-down direction A2. The upper-side end portion of the second pipe portion 162 in the vehicle up-down direction A2 is connected to the condenser 14. As a result, a gas passage for causing the gas-phase working fluid to flow from the evaporator 12 toward the condenser 14 is formed in the first gas passage portion 16. It should be noted that the part where the first pipe portion 161 and the second pipe portion 162 are interconnected in the first gas passage portion 16 may have an R shape.

The second gas passage portion 17, which is a second gas-phase passage portion, is positioned above the first gas passage portion 16 and guides the gas-phase working fluid evaporated by the evaporator 12 to the condenser 14. The second gas passage portion 17 is configured by a first pipe portion 171, a second pipe portion 172, a third pipe portion 173, a fourth pipe portion 174, and a fifth pipe portion 175 by means of a piping member or the like. The first pipe portion 171 stands to the upper side in the vehicle up-down direction A2 with respect to the first pipe portion 161 of the first gas passage portion 16. The second pipe portion 172 extends in the vehicle front-rear direction A3. The third pipe portion 173 is inclined at a falling gradient to the vehicle front side when viewed from the vehicle rear side in the vehicle front-rear direction A3 and extends in the vehicle up-down direction A2. The fourth pipe portion 174 extends in the vehicle front-rear direction A3. The fifth pipe portion 175 is inclined at a rising gradient to the vehicle front side when viewed from the vehicle rear side in the vehicle front-rear direction A3 and extends in the vehicle up-down direction A2.

The lower-side end portion of the first pipe portion 171 in the vehicle up-down direction A2 is connected to the vehicle-rear-side end portion of the first pipe portion 161 in the vehicle front-rear direction A3 that is in the first gas passage portion 16. The upper-side end portion of the first pipe portion 171 in the vehicle up-down direction A2 is connected to the vehicle-rear-side end portion of the second pipe portion 172 in the vehicle front-rear direction A3. The vehicle-front-side end portion of the second pipe portion 172 in the vehicle front-rear direction A3 is connected to the upper-side end portion of the third pipe portion 173 in the vehicle up-down direction A2. The lower-side end portion of the third pipe portion 173 in the vehicle up-down direction A2 is connected to the vehicle-rear-side end portion of the fourth pipe portion 174 in the vehicle front-rear direction A3. The vehicle-front-side end portion of the fourth pipe portion 174 in the vehicle front-rear direction A3 is connected to the lower-side end portion of the fifth pipe portion 175 in the vehicle up-down direction A2. The upper-side end portion of the fifth pipe portion 175 in the vehicle up-down direction A2 is connected to the condenser 14. As a result, a gas passage for causing the gas-phase working fluid to flow from the evaporator 12 toward the condenser 14 is formed in the second gas passage portion 17. It should be noted that the parts where the pipe portions are interconnected in the second gas passage portion 17 may have an R shape.

In addition, in the cooling device 1 according to the first embodiment, a horn portion 170 is formed by the first pipe portion 171, the second pipe portion 172, and the third pipe portion 173 of the second gas passage portion 17. The horn portion 170 is formed in the end portion of the second gas passage portion 17 that is on the vehicle rear side (one side in the predetermined direction) in the vehicle front-rear direction A3. The horn portion 170 is a rising portion and at least a part of the horn portion 170 rises above the surroundings. Here, in the present embodiment, the end portion of the second gas passage portion 17 that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 3. The horn portion 170 has a curved convex shape such that the third pipe portion 173 heads downward via the second pipe portion 172 after the first pipe portion 171 rises upward. It should be noted that the curved convex shape includes a so-called bent convex shape.

The liquid passage portion 18, which is a liquid-phase passage portion, guides the liquid-phase working fluid condensed by the condenser 14 to the evaporator 12. The liquid passage portion 18 is configured by a first pipe portion 181 and a second pipe portion 182 by means of a piping member or the like. The first pipe portion 181 extends in the vehicle up-down direction A2. The second pipe portion 182 extends in the vehicle front-rear direction A3.

The upper-side end portion of the first pipe portion 181 in the vehicle up-down direction A2 is connected to the condenser 14. The lower-side end portion of the first pipe portion 181 in the vehicle up-down direction A2 is connected to the vehicle-front-side end portion of the second pipe portion 182 in the vehicle front-rear direction A3. Respective fluid inlet portions 422 of three evaporators 12 are connected to the second pipe portion 182. As a result, a liquid passage for causing the liquid-phase working fluid to flow from the condenser 14 toward the evaporator 12 is formed in the liquid passage portion 18. It should be noted that the part where the first pipe portion 181 and the second pipe portion 182 are interconnected in the liquid passage portion 18 may have an R shape.

As illustrated in FIG. 2, in the cooling device 1 according to the first embodiment, the first and second gas passage portions 16 and 17 and the liquid passage portion 18 are separately disposed on both sides of the battery pack 500 in a vehicle width direction A4, which is orthogonal to the vehicle front-rear direction A3. It should be noted that the vehicle width direction A4 is the same as the battery cell arrangement direction A1 in the first embodiment. Here, in a case where the first gas passage portion 16, the second gas passage portion 17, and the liquid passage portion 18 are collectively disposed on one side of the battery pack 500 in the vehicle width direction A4, one of the spaces that are provided on both sides of the battery pack 500 in the vehicle width direction A4 so that damage to the battery pack 5 is prevented when the vehicle undergoes a collision in the vehicle width direction A4 becomes a dead space. In contrast, it is possible to make the most of both of the spaces provided on both sides of the battery pack 500 in the vehicle width direction A4 when the first and second gas passage portions 16 and 17 and the liquid passage portion 18 are separately disposed on both sides of the battery pack 500 in the vehicle width direction A4, as in the cooling device 1 according to the first embodiment.

In addition, in a case where the first gas passage portion 16, the second gas passage portion 17, and the liquid passage portion 18 are collectively disposed on one side of the battery pack 500 in the vehicle width direction A4, return piping is necessary so that the working fluid that has flowed from one end side to the other end side in the vehicle width direction A4 through the evaporator 12 returns from the other end side to the one end side. Accordingly, an increase in the size of the battery pack 500 arises by the return piping being provided. In contrast, the return piping is not necessary and therefore the size of the battery pack 500 can be reduced when the first and second gas passage portions 16 and 17 and the liquid passage portion 18 are separately disposed on both sides of the battery pack 500 in the vehicle width direction A4, as in the cooling device 1 according to the first embodiment.

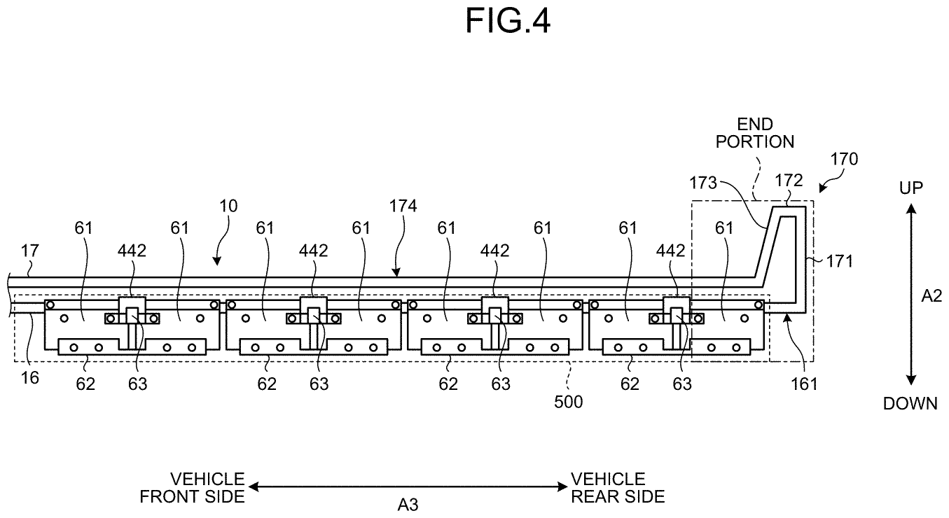

A pair of end plates 61 as illustrated in FIG. 4 are provided on both end sides of the battery pack 5 in the battery cell arrangement direction A1 (vehicle width direction A4) in the cooling device 1 according to the first embodiment (only the end plates 61 that are on one end side are illustrated in FIG. 4). The respective lower parts of two battery packs 5 adjacent to each other in the vehicle front-rear direction A3 are covered with a common battery case 62 and the adjacent battery packs 5 are fixed to the battery case 62. In addition, two end plates 61 adjacent to each other in the vehicle front-rear direction A3 and provided so as to correspond respectively to two adjacent battery packs 5 are interconnected by a connecting member 63.

The first pipe portion 161 of the first gas passage portion 16 is disposed between the battery pack 5 and the end plate 61 on the left side of the vehicle in the vehicle width direction A4 and the first pipe portion 161 of the first gas passage portion 16 is fixed to the end plate 61 on the left side of the vehicle. In addition, the second pipe portion 182 of the liquid passage portion 18 is disposed between the battery pack 5 and the end plate 61 on the right side of the vehicle in the vehicle width direction A4 and the second pipe portion 182 of the liquid passage portion 18 is fixed to the end plate 61 on the right side of the vehicle. It should be noted that the second gas passage portion 17 is disposed outside the battery pack 500 without being fixed to the end plate 61. Specifically, the second gas passage portion 17 is disposed above the battery pack 500 in the vehicle up-down direction A2. In addition, the second gas passage portion 17 is disposed above the battery pack 500 in the vehicle up-down direction A2. As a result, the battery pack 500 can be smaller in size than in a case where the second gas passage portion 17 is disposed between the end plate 61 and the battery pack 5 in the vehicle width direction A4 and the second gas passage portion 17 is fixed to the end plate 61. In addition, the second gas passage portion 17 can be easily disposed above and behind.

It should be noted that it is possible to save space when each of the pipe portions of the first gas passage portion 16 and the liquid passage portion 18 that are not fixed to the respective end plates 61, the second gas passage portion 17 or the like passes through the floor tunnel of the vehicle or is hidden by an interior component such as a door trim and passes through the passenger compartment.

A basic operation of the cooling device 1 according to the first embodiment will be described below with reference to FIG. 1.

In the cooling device 1, the heat of the battery pack 5 moves to the evaporator 12 when the battery temperature of the battery pack 5 rises due to, for example, self-heat generation during the traveling of the vehicle. In the evaporator 12, a part of the liquid-phase working fluid evaporates as a result of heat absorption from the battery pack 5. The battery pack 5 is cooled by the latent heat of evaporation of the working fluid that is present in the evaporator 12 and the temperature of the battery pack 5 decreases.

The working fluid evaporated by the evaporator 12 flows out to the first gas passage portion 16 from the evaporator 12 and moves to the condenser 14 via the first gas passage portion 16, as indicated by the arrow FL1 in FIG. 1.

In the condenser 14, the liquid-phase working fluid condensed by the gas-phase working fluid radiating heat descends by gravity. As a result, the liquid-phase working fluid condensed in the condenser 14 flows out to the liquid passage portion 18 from the condenser 14 and moves to the evaporator 12 via the liquid passage portion 18, as indicated by the arrow FL2 in FIG. 1. Then, in the evaporator 12, a part of the liquid-phase working fluid that has flowed in is evaporated as a result of heat absorption from the battery pack 5.

As described above, in the cooling device 1, the working fluid circulates between the evaporator 12 and the condenser 14 while undergoing a change in phase between the gas state and the liquid state and heat is transported from the evaporator 12 to the condenser 14. As a result, the battery pack 5 to be cooled is cooled. The cooling device 1 has a configuration in which the working fluid naturally circulates inside the working fluid circuit 10 even without a drive force required for working fluid circulation by means of a compressor or the like. Accordingly, the cooling device 1 is capable of realizing efficient cooling of the battery pack 5 in which both power consumption and noise are reduced.

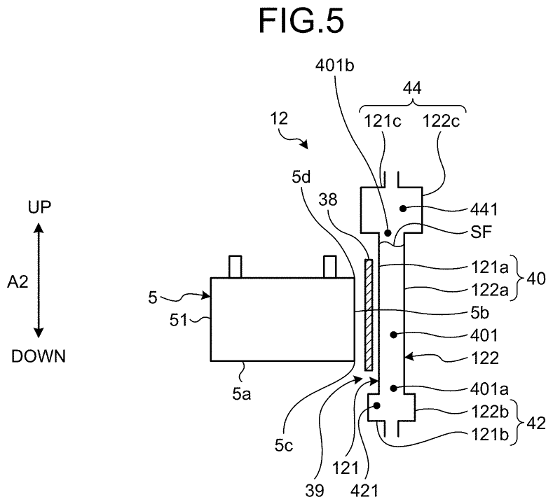

Next, the structure of the evaporator 12 will be described. As illustrated in FIGS. 1 and 5, the evaporator 12 includes a fluid evaporation unit 40, a liquid supply unit 42 connected to the lower end of the fluid evaporation unit 40, and a fluid outflow unit 44 connected to the upper end of the fluid evaporation unit 40. The fluid outflow unit 44 is disposed above the liquid supply unit 42 and the fluid evaporation unit 40 and the liquid supply unit 42 is disposed below the fluid outflow unit 44 and the fluid evaporation unit 40. It should be noted that each component in FIG. 5 is illustrated with an inter-component gap intentionally illustrated so that the disposition of each component is clearly illustrated.

The fluid evaporation unit 40 is connected to the battery side surface 5b, which is an upright surface of the battery pack 5, so as to be capable of conducting heat. Specifically, the fluid evaporation unit 40 is connected to the battery pack 5 so as to be capable of conducting heat by being in contact with a heat conduction material 38, which is interposed between the fluid evaporation unit 40 and the battery pack 5. For example, the fluid evaporation unit 40 is held in a state of being pressed against the battery pack 5 so that the thermal conductivity between the fluid evaporation unit 40 and the battery pack 5 is increased.

The heat conduction material 38 has electrical insulating properties and high thermal conductivity. The heat conduction material 38 is sandwiched between the fluid evaporation unit 40 and the battery pack 5 so that the thermal conductivity between the fluid evaporation unit 40 and the battery pack 5 is increased. For example, grease or a sheet-shaped material is adopted as the heat conduction material 38. It should be noted that the fluid evaporation unit 40 may be in direct contact with the battery pack 5 without the heat conduction material 38 being provided insofar as electrical insulating properties and thermal conductivity are sufficiently ensured between the fluid evaporation unit 40 and the battery pack 5.

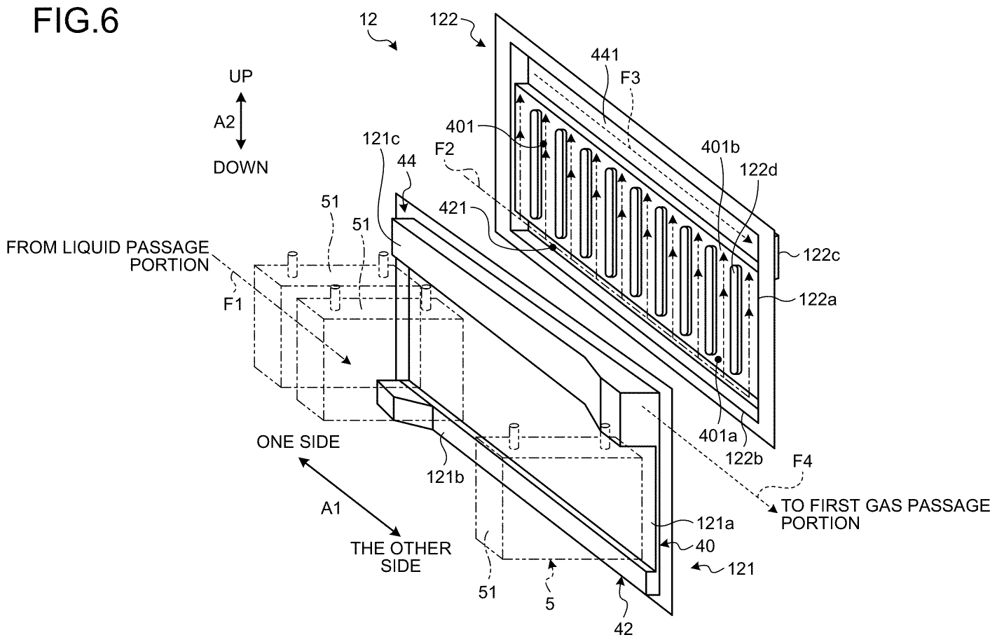

As illustrated in FIGS. 5 and 6, a plurality of evaporation flow paths 401 extending in the vehicle up-down direction A2 are formed in the fluid evaporation unit 40. In other words, each of the plurality of evaporation flow paths 401 extends along the battery side surface 5b to a side surface upper end 5d side from a side surface lower end 5c side of the battery side surface 5b.

Further, the fluid evaporation unit 40 evaporates the working fluid flowing through the plurality of evaporation flow paths 401 with the heat of the battery pack 5. In other words, the liquid-phase working fluid flowing into each evaporation flow path 401 is vaporized in each evaporation flow path 401 while flowing through each evaporation flow path 401. It should be noted that FIG. 5 illustrates a liquid surface SF of the liquid-phase working fluid. In addition, in FIG. 6, the heat conduction material 38, some of the plurality of battery cells 51 of the battery packs 5, and so on are not illustrated and the battery cells 51 are indicated by two-dot chain lines for easier understanding.

A supply flow path 421 extending in the battery cell arrangement direction A1 is formed in the liquid supply unit 42. In addition, an outflow flow path 441 extending in the battery cell arrangement direction A1 is formed in the fluid outflow unit 44.

Focusing on the component members of the evaporator 12, the evaporator 12 has a structure in which plates are stacked. Accordingly, the evaporator 12 has a first plate member 121 and a second plate member 122. Further, the evaporator 12 is configured by the pair of plate members 121 and 122 being stacked and joined to each other at respective peripheral edge parts of the plate members 121 and 122. Each of the first plate member 121 and the second plate member 122 is made of a metal such as an aluminum alloy having high thermal conductivity and is a molded article formed by press working or the like. In addition, the first plate member 121 and the second plate member 122 are joined by, for example, brazing.

Specifically, the first plate member 121 has a first evaporation forming portion 121a included in the fluid evaporation unit 40, a first supply forming portion 121b included in the liquid supply unit 42, and a first outflow forming portion 121c included in the fluid outflow unit 44. In addition, the second plate member 122 has a second evaporation forming portion 122a included in the fluid evaporation unit 40, a second supply forming portion 122b included in the liquid supply unit 42, and a second outflow forming portion 122c included in the fluid outflow unit 44.

Further, the evaporation flow path 401, the supply flow path 421, and the outflow flow path 441 are formed as internal spaces of the evaporator 12 by the first plate member 121 and the second plate member 122 being joined to each other. In other words, the plurality of evaporation flow paths 401 are formed between the first evaporation forming portion 121a and the second evaporation forming portion 122a by the first plate member 121 and the second plate member 122 being joined to each other. In addition, the supply flow path 421 is formed between the first supply forming portion 121b and the second supply forming portion 122b by the first plate member 121 and the second plate member 122 being joined to each other. In addition, the outflow flow path 441 is formed between the first outflow forming portion 121c and the second outflow forming portion 122c by the first plate member 121 and the second plate member 122 being joined to each other.

The first evaporation forming portion 121a is disposed between the second evaporation forming portion 122a and the battery pack 5. Accordingly, the fluid evaporation unit 40 is in contact with the heat conduction material 38 in the first evaporation forming portion 121a.

The second evaporation forming portion 122a of the second plate member 122 has a plurality of projecting portions 122d protruding toward the first evaporation forming portion 121a of the first plate member 121. Each of the plurality of projecting portions 122d is formed so as to extend in the vehicle up-down direction A2. In other words, each of the plurality of projecting portions 122d is formed so as to extend from the liquid supply unit 42 side to the fluid outflow unit 44 side of the fluid evaporation unit 40.

Each of the plurality of projecting portions 122d abuts against the first evaporation forming portion 121a and is joined to the first evaporation forming portion 121a. This joining is performed by, for example, brazing. The plurality of projecting portions 122d partition the plurality of evaporation flow paths 401 from each other by abutting against and being joined to the first evaporation forming portion 121a.

In addition, the plurality of projecting portions 122d are disposed side by side at intervals in the battery cell arrangement direction A1, and thus the plurality of evaporation flow paths 401 are disposed side by side in the battery cell arrangement direction A1. Specifically, the projecting portions 122d and the evaporation flow paths 401 are alternately arranged in the battery cell arrangement direction A1. For example, the evaporation flow paths 401 are provided in the same number as the battery cells 51 and disposed such that one evaporation flow path 401 is assigned to each battery cell 51.

In addition, each of the flow path cross sections of the plurality of evaporation flow paths 401 has a flat cross-sectional shape extending in the battery cell arrangement direction A1. In other words, in a cross section orthogonal to the direction in which the evaporation flow path 401 extends (that is, the vehicle up-down direction A2 in the present embodiment), the cross-sectional shape of the evaporation flow path 401 is a flat shape in which the battery cell arrangement direction A1 is a longitudinal direction.

In addition, each of the evaporation flow paths 401 has the lower end of the evaporation flow path 401 as an upstream end 401a on the upstream side in the direction in which the working fluid flows and the upper end of the evaporation flow path 401 as a downstream end 401b on the downstream side in the direction in which the working fluid flows. As indicated by the one-dot chain line and broken line arrows in FIG. 6, the working fluid flows from the upstream end 401a to the downstream end 401b in the evaporation flow path 401. In other words, the working fluid flows upward from below in the evaporation flow path 401.

Each of the upstream ends 401a of the plurality of evaporation flow paths 401 is connected to the supply flow path 421. Accordingly, the liquid supply unit 42 distributes and supplies the liquid-phase working fluid that has flowed into the supply flow path 421 to each of the plurality of evaporation flow paths 401.

Meanwhile, each of the downstream ends 401b of the plurality of evaporation flow paths 401 is connected to the outflow flow path 441. Accordingly, the working fluid flows into the outflow flow path 441 from each of the plurality of evaporation flow paths 401. Then, the fluid outflow unit 44 causes the working fluid that has flowed into the outflow flow path 441 to flow out to the first gas passage portion 16 and the second gas passage portion 17.

As illustrated in FIGS. 1 and 6, the liquid supply unit 42 is formed so as to extend in the battery cell arrangement direction A1, and thus the liquid supply unit 42 has one end portion 42a on one side in the battery cell arrangement direction A1 and has the other end portion 42b on the other side in the battery cell arrangement direction A1. The fluid inlet portion 422 to which the liquid passage portion 18 is connected is provided in the one end portion 42a of the liquid supply unit 42. The fluid inlet portion 422 communicates with the supply flow path 421. Meanwhile, the other end portion 42b of the liquid supply unit 42 forms the end of the supply flow path 421 that is on the other side in the battery cell arrangement direction A1 and blocks the end on the other side.

The fluid outflow unit 44 is formed so as to extend in the battery cell arrangement direction A1, and thus the fluid outflow unit 44 has one end portion 44a on one side in the battery cell arrangement direction A1 and has the other end portion 44b on the other side in the battery cell arrangement direction A1. The fluid outlet portion 442 to which the first gas passage portion 16 is connected is provided in the other end portion 44b of the fluid outflow unit 44. The fluid outlet portion 442 communicates with the outflow flow path 441. Meanwhile, the one end portion 44a of the fluid outflow unit 44 forms the end of the outflow flow path 441 that is on one side in the battery cell arrangement direction A1 and blocks the end on the one side. The fluid outflow unit 44 performs gas-liquid separation of a bubble flow in which the evaporated working fluid gas blows up together with the liquid-phase working fluid and the outflow flow path 441 serves as a flow path for discharging the separated working fluid gas.

Although the fluid evaporation unit 40 is in contact with the heat conduction material 38 as illustrated in FIGS. 1 and 5, the liquid supply unit 42 is disposed apart from both the battery pack 5 and the heat conduction material 38. In other words, the air that is interposed between the liquid supply unit 42 and the battery pack 5 and the heat conduction material 38 functions as a heat insulating portion 39 that hinders heat transfer therebetween. Further, the liquid supply unit 42 is not thermally connected to the battery pack 5 since the heat insulating portion 39 is disposed so as to be interposed between the liquid supply unit 42 and the battery pack 5 and the heat conduction material 38. In addition, the fluid outflow unit 44 is also disposed apart from both the battery pack 5 and the heat conduction material 38, and thus the fluid outflow unit 44 is not thermally connected to the battery pack 5.

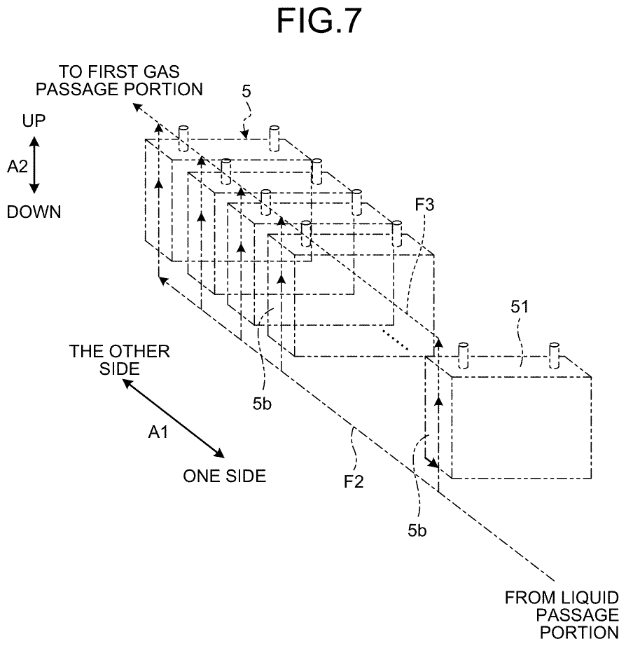

As described above, the outflow flow path 441, the supply flow path 421, and the evaporation flow path 401 of the evaporator 12 communicate with each other, and thus the working fluid flows through the evaporator 12, as indicated by the one-dot chain line and broken line arrows illustrated in FIGS. 6 and 7. It should be noted that the one-dot chain line arrow represents the flow of the liquid-phase working fluid in the evaporator 12 and the broken line arrow represents the flow of the gas-phase working fluid in the evaporator 12.

Specifically, the liquid-phase working fluid from the liquid passage portion 18 flows into the supply flow path 421 from the liquid passage portion 18 via the fluid inlet portion 422 illustrated in FIG. 1, as indicated by the arrow F1 in FIG. 6. The liquid-phase working fluid that has flowed in flows to the other side from one side in the battery cell arrangement direction A1 in the supply flow path 421, as indicated by the arrow F2 in FIG. 6. Then, the liquid-phase working fluid is distributed from the supply flow path 421 to each of the plurality of evaporation flow paths 401. At this time, the liquid-phase working fluid as it is flows into each evaporation flow path 401 since the liquid supply unit 42 is unlikely to receive the heat of the battery pack 5. In other words, the liquid-phase working fluid supplied from the condenser 14 is supplied as it is, without boiling and without becoming a bubble flow, to the vicinity of the lower side of each battery cell 51 via the supply flow path 421.

In each evaporation flow path 401, the liquid-phase working fluid is vaporized by the heat of the battery pack 5 while flowing upward from below. In other words, the working fluid takes heat from each battery cell 51 and evaporates while flowing through the evaporation flow path 401. Accordingly, in each evaporation flow path 401, the working fluid flows into the outflow flow path 441 only in the gas phase or in the gas-liquid two-phases.

The working fluid that has flowed into the outflow flow path 441 undergoes gas-liquid separation and flows to the other side from one side in the battery cell arrangement direction A1 in the outflow flow path 441, as indicated by the arrow F3 in FIG. 6. The gas-phase working fluid that has flowed to the end on the other side in the battery cell arrangement direction A1 in the outflow flow path 441 flows out from the fluid outlet portion 442 illustrated in FIG. 1 to the first gas passage portion 16, as indicated by the arrow F4 in FIG. 6.

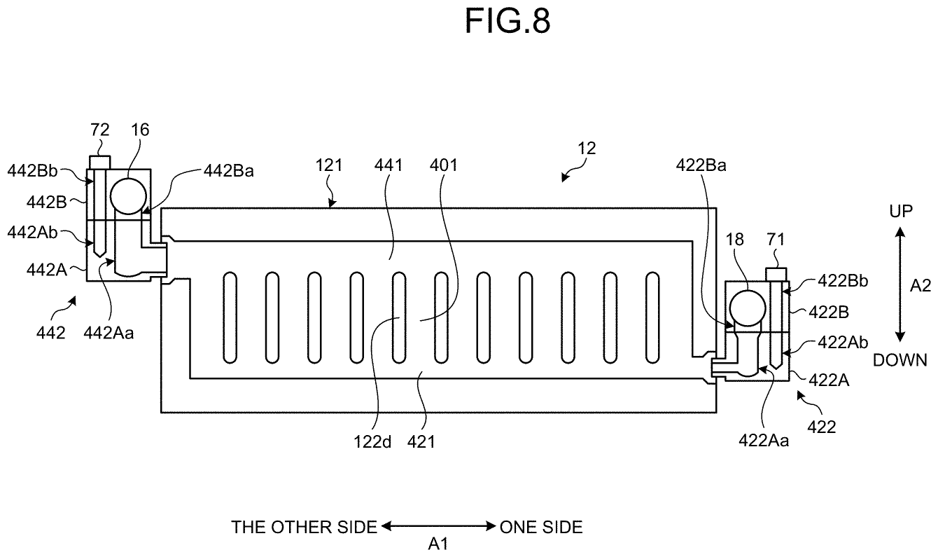

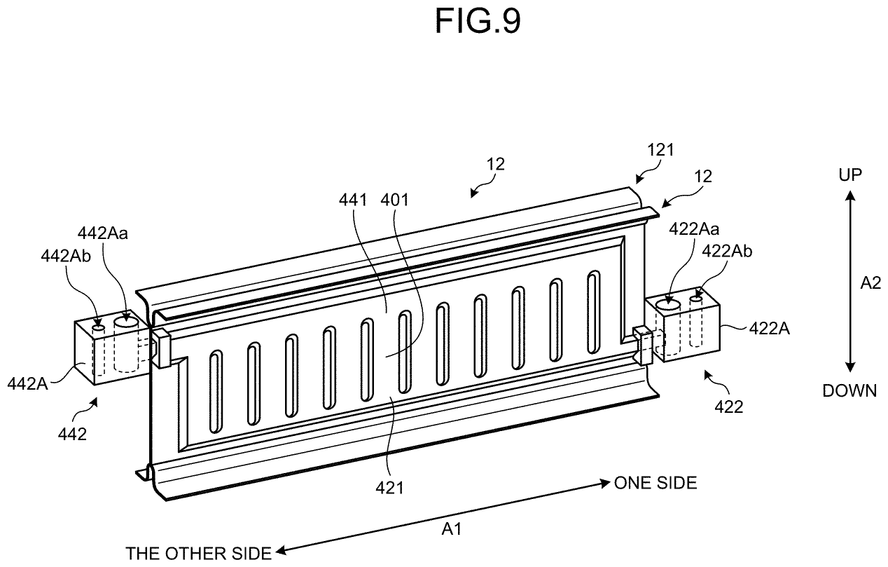

FIG. 8 is a diagram illustrating the interconnection structure of the first gas passage portion 16, the liquid passage portion 18, and the evaporator 12. FIG. 9 is a perspective view of the evaporator 12 provided with a lower-side fluid inlet portion 422A and a lower-side fluid outlet portion 442A. The fluid inlet portion 422 is provided in the end portion of the evaporator 12 that is on one side in the battery cell arrangement direction A1. The fluid inlet portion 422 communicates with the supply flow path 421 in the evaporator 12 and is a liquid phase-side connection portion for interconnecting the liquid passage portion 18 and the evaporator 12. In addition, the fluid outlet portion 442 is provided in the end portion of the evaporator 12 that is on the other side in the battery cell arrangement direction A1. The fluid outlet portion 442 communicates with the outflow flow path 441 in the evaporator 12 and is a gas phase-side connection portion for interconnecting the first gas passage portion 16 and the evaporator 12.

The fluid inlet portion 422 is configured to be divided into the lower-side fluid inlet portion 422A and an upper-side fluid inlet portion 422B in the vehicle up-down direction A2. The supply flow path 421 in the evaporator 12 and the liquid passage portion 18 in the upper-side fluid inlet portion 422B are allowed to communicate with each other by an L-shaped lower flow path 422Aa and an upper flow path 422Ba. The lower flow path 422Aa is provided in the lower-side fluid inlet portion 422A and is conductive in the battery cell arrangement direction A1 and the vehicle up-down direction A2. The upper flow path 422Ba is provided in the upper-side fluid inlet portion 422B and is conductive in the vehicle up-down direction A2.

In addition, the lower-side fluid inlet portion 422A and the upper-side fluid inlet portion 422B are provided with a lower screw hole 422Ab and an upper screw hole 422Bb, respectively, communicating with each other in the vehicle up-down direction A2. Further, a bolt 71 is inserted through the upper screw hole 422Bb and the lower screw hole 422Ab from above the upper-side fluid inlet portion 422B, the bolt 71 is screwed with the upper screw hole 422Bb and the lower screw hole 422Ab, and then the lower-side fluid inlet portion 422A and the upper-side fluid inlet portion 422B are fastened.

The fluid outlet portion 442 is configured to be divided into the lower-side fluid outlet portion 442A and an upper-side fluid outlet portion 442B in the vehicle up-down direction A2. The outflow flow path 441 in the evaporator 12 and the first gas passage portion 16 in the upper-side fluid outlet portion 442B are allowed to communicate with each other by an L-shaped lower flow path 442Aa and an upper flow path 442Ba. The lower flow path 442Aa is provided in the lower-side fluid outlet portion 442A and is conductive in the battery cell arrangement direction A1 and the vehicle up-down direction A2. The upper flow path 442Ba is provided in the upper-side fluid outlet portion 442B and is conductive in the vehicle up-down direction A2.

In addition, the lower-side fluid outlet portion 442A and the upper-side fluid outlet portion 442B are provided with a lower screw hole 442Ab and an upper screw hole 442Bb, respectively, communicating with each other in the vehicle up-down direction A2. Further, a bolt 72 is inserted through the upper screw hole 442Bb and the lower screw hole 442Ab from above the upper-side fluid outlet portion 442B, the bolt 72 is screwed with the upper screw hole 442Bb and the lower screw hole 442Ab, and then the lower-side fluid outlet portion 442A and the upper-side fluid outlet portion 442B are fastened.

As described above, in the cooling device 1 according to the first embodiment, the work of connection to the liquid passage portion 18 by means of the fluid inlet portion 422 and the work of connection to the first gas passage portion 16 by means of the fluid outlet portion 442 can be performed in one direction, specifically from above, with respect to the evaporator 12 mounted in the vehicle. As a result, it is possible to reduce a work space (such as a tool space at a time when work is performed by means of a tool and a surrounding area for the work) or improve work efficiency as compared with a case where the work of connection to the liquid passage portion 18 by means of the fluid inlet portion 422 and the work of connection to the first gas passage portion 16 by means of the fluid outlet portion 442 are performed from different directions with respect to the evaporator 12 mounted in the vehicle.

In addition, in the first embodiment, it is preferable that the battery pack 500 is configured to be placed in or fixed to the vehicle from one direction, from above in particular. In this manner, the work space for placing the cooling device 1 and the battery pack 5 in the vehicle or fixing the cooling device 1 and the battery pack 5 to the vehicle can be reduced or work efficiency can be improved. As a result, it is possible to, for example, reduce the size of the battery pack 500 or improve the productivity of the vehicle.

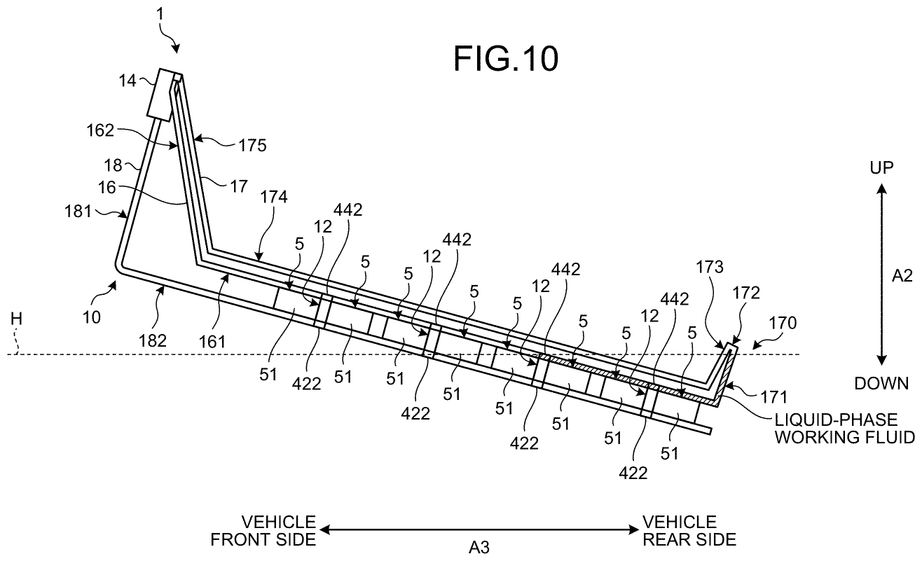

FIG. 10 is a diagram illustrating the posture of the cooling device 1 according to the first embodiment during uphill traveling. As illustrated in FIG. 10, the posture of the cooling device 1 during uphill traveling is inclined with respect to the horizontal direction such that the vehicle front side is higher than the vehicle rear side in the vehicle front-rear direction A3. In other words, in the cooling device 1 at a time of uphill traveling, one side and the other side where the condenser 14 is positioned in the predetermined direction relatively move in the vehicle up-down direction A2 such that the other side is higher in position than the one side. When the cooling device 1 is inclined in this manner, a flow of the liquid-phase working fluid leading to liquid-phase working fluid accumulation is generated by gravity or the like on the vehicle rear side in the vehicle front-rear direction A3, which is the lower portion of the working fluid circuit 10.

Accordingly, during uphill traveling, the liquid-phase working fluid that has flowed into each evaporator 12 from the liquid passage portion 18 via each fluid inlet portion 422 may flow out to the first gas passage portion 16 and the second gas passage portion 17 via each fluid outlet portion 442 while maintaining the liquid-phase state. At this time, the liquid-phase working fluid that has flowed out to the first gas passage portion 16 accumulates in the first pipe portion 161 up to the position of a liquid level H illustrated in FIG. 10. In addition, the liquid-phase working fluid that has flowed out to the second gas passage portion 17 accumulates in the first pipe portion 171 up to the position of the liquid level H illustrated in FIG. 10, which is positioned below the upper end of the first pipe portion 171.

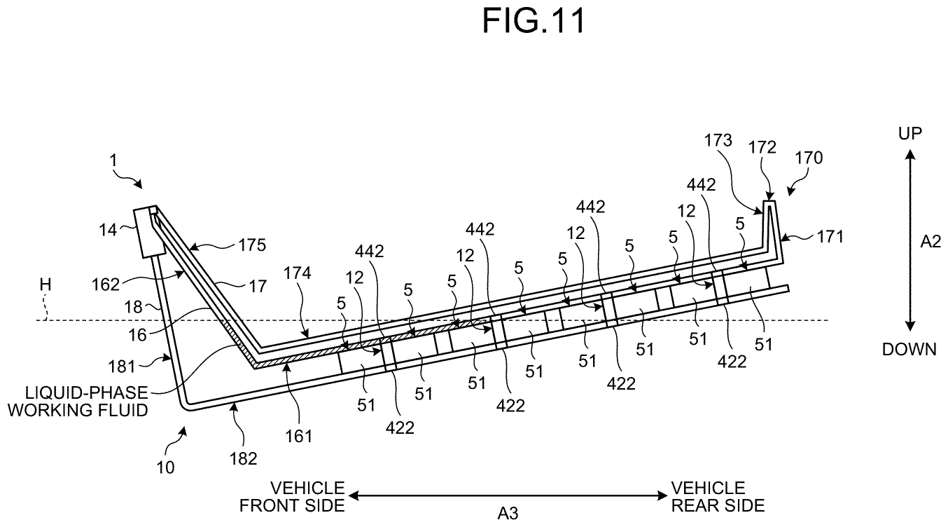

FIG. 11 is a diagram illustrating the posture of the cooling device 1 according to the first embodiment during downhill traveling. As illustrated in FIG. 11, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, a part of the liquid-phase working fluid accumulated in the first pipe portion 161 of the first gas passage portion 16 during uphill traveling flows into each evaporator 12 via each fluid outlet portion 442 connected to the first pipe portion 161. Further, the remaining liquid-phase working fluid in the first gas passage portion 16 accumulates up to the position of the liquid level H illustrated in FIG. 11 around the connection part between end portions of the first and second pipe portions 161 and 162, which is the lower portion of the first gas passage portion 16, during downhill traveling. Accordingly, the first gas passage portion 16 is blocked by the liquid-phase working fluid in the event of continuous uphill-to-downhill switching.

In addition, in the event of continuous uphill-to-downhill switching, most of the liquid-phase working fluid accumulated in the first pipe portion 171 of the second gas passage portion 17 during uphill traveling flows out from the lower end of the first pipe portion 171 to the first gas passage portion 16 without flowing out to the second pipe portion 172 side beyond the upper end of the first pipe portion 171. Accordingly, in the event of continuous uphill-to-downhill switching, a gas passage portion for causing the gas-phase working fluid to flow from the evaporator 12 toward the condenser 14 is secured in the second gas passage portion 17.

Further, the gas-phase working fluid that has flowed out to the first pipe portion 161 of the first gas passage portion 16 from each evaporator 12 via each fluid outlet portion 442 during downhill traveling flows into the first pipe portion 171 of the second gas passage portion 17 from the vehicle rear side in the vehicle front-rear direction A3. As a result, the gas-phase working fluid flows into the condenser 14 through the second gas passage portion 17.

As described above, in the cooling device 1 according to the first embodiment, the first gas passage portion 16 and the second gas passage portion 17 are interconnected via the horn portion 170 on the vehicle rear side in the vehicle front-rear direction A3. As a result, it is possible to prevent accumulation of the liquid-phase working fluid in the second gas passage portion 17, which is concerned at a time of continuous uphill-to-downhill switching. As a result, in the cooling device 1 according to the first embodiment, the gas-phase working fluid can be moved from the evaporator 12 to the condenser 14 through the second gas passage portion 17 in the event of continuous uphill-to-downhill switching.

It should be noted that the liquid-phase working fluid may flow out from the second pipe portion 172 to the fourth pipe portion 174 through the third pipe portion 173 in the event of continuous uphill-to-downhill switching when the liquid level H reaches the position of the second pipe portion 172 of the second gas passage portion 17 during uphill traveling and the liquid-phase working fluid accumulates in the second pipe portion 172. When the liquid-phase working fluid flows out to the fourth pipe portion 174 of the second gas passage portion 17 as described above, the liquid-phase working fluid accumulates around the connection part between end portions of the fourth and fifth pipe portions 174 and 175, which is the lower portion of the second gas passage portion 17, during downhill traveling. Accordingly, the second gas passage portion 17 as well as the first gas passage portion 16 is blocked by the liquid-phase working fluid in the event of continuous uphill-to-downhill switching.

Accordingly, the length of the first pipe portion 171 of the second gas passage portion 17, which constitutes the horn portion 170, in the vehicle up-down direction A2 may be set to a length at which the liquid level H does not reach the upper-side end portion of the first pipe portion 171 in the vehicle up-down direction A2 at the maximum gradient assumed during uphill traveling such as a rising gradient of 18%. In addition, h may be calculated as (L/2)×0.18 when, for example, L is the length from the end of the battery pack 500 on the vehicle front side in the vehicle front-rear direction A3 to the lower end of the first pipe portion 171 and h is the length of the first pipe portion 171 in the vehicle up-down direction A2.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. In this case, the length of the first pipe portion 171 of the second gas passage portion 17, which constitutes the horn portion 170, in the vehicle up-down direction A2 may be set to a length at which the liquid level H does not reach the upper-side end portion of the first pipe portion 171 in the vehicle up-down direction A2 at the maximum gradient assumed during downhill traveling. In this manner, it is possible to prevent accumulation of the liquid-phase working fluid in the second gas passage portion 17, which is concerned at a time of continuous downhill-to-uphill switching, and the gas-phase working fluid can be moved from the evaporator 12 to the condenser 14 through the second gas passage portion 17. Further, the position of the condenser 14 is not limited to the end portion on the other side, which is opposite to one side where the horn portion 170 is positioned in the predetermined direction.

In the cooling device 1 according to the first embodiment, it is possible to suppress the liquid-phase working fluid flowing into and accumulating in the second gas passage portion 17 in a case where the other side relatively moves up and down with respect to one side in the predetermined direction where the horn portion 170 is positioned.

### Second Embodiment

Hereinafter, a second embodiment of the cooling device according to the present disclosure will be described. It should be noted that description of parts common to the first and second embodiments will be omitted as appropriate.

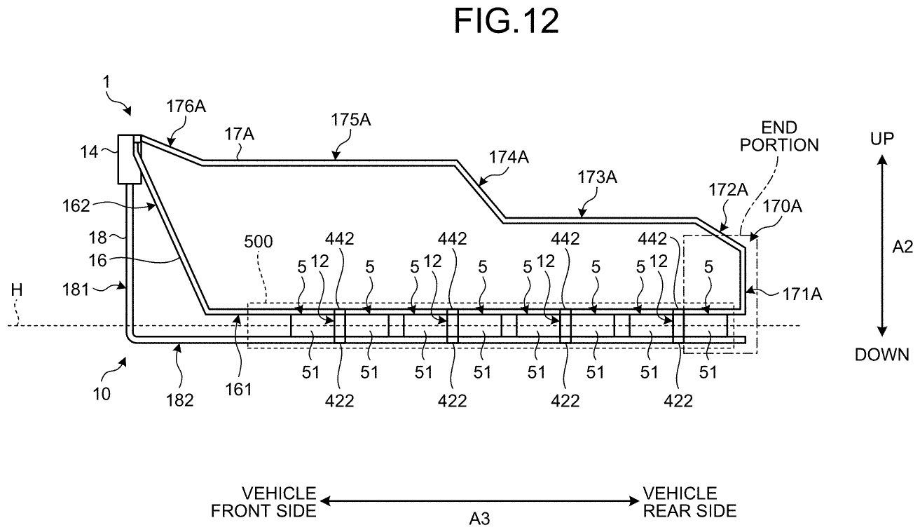

FIG. 12 is a side view illustrating a schematic configuration of the cooling device 1 according to the second embodiment. It should be noted that FIG. 12 illustrates the posture of the cooling device 1 at a time when the vehicle is positioned on a horizontal road surface. In the cooling device 1 illustrated in FIG. 12, the condenser 14 is positioned on the other side in the predetermined direction, that is, the vehicle front side in the vehicle front-rear direction A3.

The shape of a second gas passage portion 17A of the cooling device 1 according to the second embodiment differs from the shape of the second gas passage portion 17 of the cooling device 1 according to the first embodiment. The second gas passage portion 17A is positioned above the first gas passage portion 16 and guides the gas-phase working fluid evaporated by the evaporator 12 to the condenser 14. The second gas passage portion 17A is configured by a first pipe portion 171A, a second pipe portion 172A, a third pipe portion 173A, a fourth pipe portion 174A, a fifth pipe portion 175A, and a sixth pipe portion 176A by means of a piping member or the like. The first pipe portion 171A stands to the upper side in the vehicle up-down direction A2 with respect to the first pipe portion 161 of the first gas passage portion 16. The second pipe portion 172A is inclined at a rising gradient to the vehicle front side when viewed from the vehicle rear side in the vehicle front-rear direction A3 and extends in the vehicle up-down direction A2. The third pipe portion 173A extends in the vehicle front-rear direction A3. The fourth pipe portion 174A is inclined at a rising gradient to the vehicle front side when viewed from the vehicle rear side in the vehicle front-rear direction A3 and extends in the vehicle up-down direction A2. The fifth pipe portion 175A extends in the vehicle front-rear direction A3. The sixth pipe portion 176A is inclined at a rising gradient to the vehicle front side when viewed from the vehicle rear side in the vehicle front-rear direction A3 and extends in the vehicle up-down direction A2.

As illustrated in FIG. 12, the lower-side end portion of the first pipe portion 171A in the vehicle up-down direction A2 is connected to the vehicle-rear-side end portion of the first pipe portion 161 in the vehicle front-rear direction A3 that is in the first gas passage portion 16. The upper-side end portion of the first pipe portion 171A in the vehicle up-down direction A2 is connected to the vehicle-rear-side end portion of the second pipe portion 172A in the vehicle front-rear direction A3. The vehicle-front-side end portion of the second pipe portion 172A in the vehicle front-rear direction A3 is connected to the vehicle-rear-side end portion of the third pipe portion 173A in the vehicle front-rear direction A3. The vehicle-front-side end portion of the third pipe portion 173A in the vehicle front-rear direction A3 is connected to the lower-side end portion of the fourth pipe portion 174A in the vehicle up-down direction A2. The upper-side end portion of the fourth pipe portion 174A in the vehicle up-down direction A2 is connected to the vehicle-rear-side end portion of the fifth pipe portion 175A in the vehicle front-rear direction A3. The vehicle-front-side end portion of the fifth pipe portion 175A in the vehicle front-rear direction A3 is connected to the lower-side end portion of the sixth pipe portion 176A in the vehicle up-down direction A2. The upper-side end portion of the sixth pipe portion 176A in the vehicle up-down direction A2 is connected to the condenser 14. As a result, a gas passage for causing the gas-phase working fluid to flow from the evaporator 12 toward the condenser 14 is formed in the second gas passage portion 17A.

In addition, in the cooling device 1 according to the second embodiment, a kick-up portion 170A is formed by the first pipe portion 171A and the second pipe portion 172A of the second gas passage portion 17A. The kick-up portion 170A is formed in the end portion of the second gas passage portion 17A that is on the vehicle rear side (one side in the predetermined direction) in the vehicle front-rear direction A3. The kick-up portion 170A is a rising portion and at least a part of the kick-up portion 170A rises above the surroundings. Here, in the present embodiment, the end portion of the second gas passage portion 17A that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 12. In addition, in the second gas passage portion 17A, the fourth pipe portion 174A extends further above the kick-up portion 170A after the third pipe portion 173A extends from the kick-up portion 170A to the vehicle front side in the vehicle front-rear direction A3.

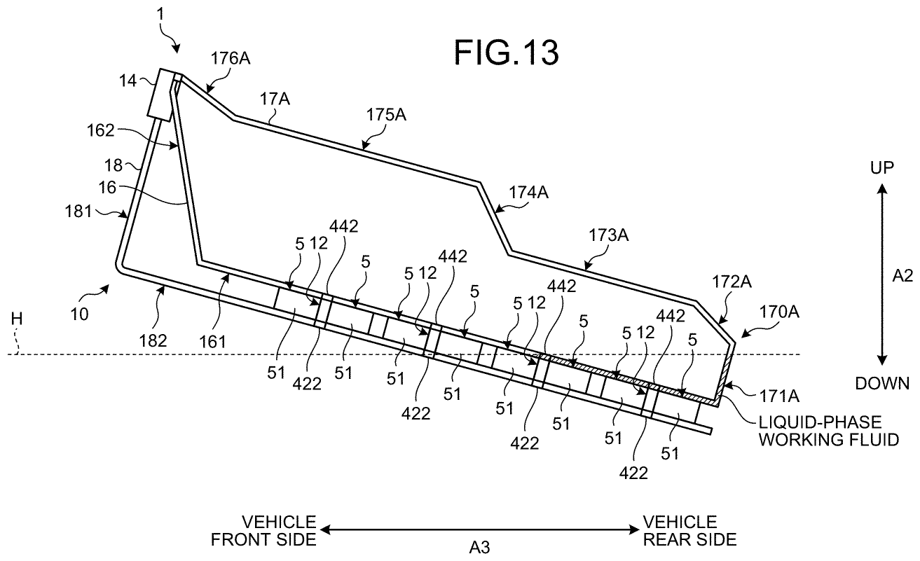

FIG. 13 is a diagram illustrating the posture of the cooling device 1 according to the second embodiment during uphill traveling. As illustrated in FIG. 13, the posture of the cooling device 1 during uphill traveling is inclined with respect to the horizontal direction such that the vehicle front side is higher than the vehicle rear side in the vehicle front-rear direction A3. In other words, in the cooling device 1 at a time of uphill traveling, one side and the other side where the condenser 14 is positioned in the predetermined direction relatively move in the vehicle up-down direction A2 such that the other side is higher in position than the one side. When the cooling device 1 is inclined in this manner, a flow of the liquid-phase working fluid leading to liquid-phase working fluid accumulation is generated by gravity or the like on the vehicle rear side in the vehicle front-rear direction A3, which is the lower portion of the working fluid circuit 10.

Accordingly, during uphill traveling, the liquid-phase working fluid that has flowed into each evaporator 12 from the liquid passage portion 18 via each fluid inlet portion 422 may flow out to the first gas passage portion 16 and the second gas passage portion 17 via each fluid outlet portion 442 while maintaining the liquid-phase state. At this time, the liquid-phase working fluid that has flowed out to the first gas passage portion 16 accumulates in the first pipe portion 161 up to the position of the liquid level H illustrated in FIG. 13. In addition, the liquid-phase working fluid that has flowed out to the second gas passage portion 17 accumulates in the first pipe portion 171A up to the position of the liquid level H illustrated in FIG. 13, which is positioned below the upper end of the first pipe portion 171A.

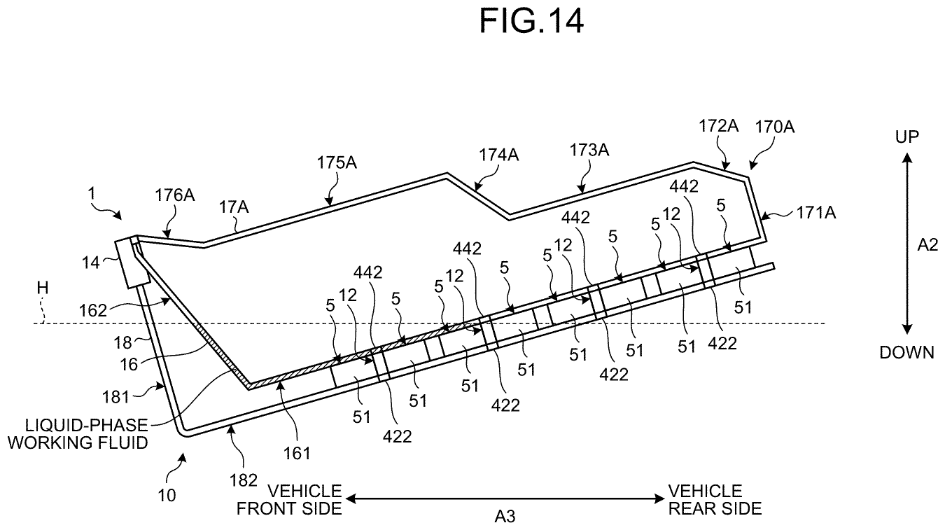

FIG. 14 is a diagram illustrating the posture of the cooling device 1 according to the second embodiment during downhill traveling. As illustrated in FIG. 14, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, a part of the liquid-phase working fluid accumulated in the first pipe portion 161 of the first gas passage portion 16 during uphill traveling flows into each evaporator 12 via each fluid outlet portion 442 connected to the first pipe portion 161. Further, the remaining liquid-phase working fluid in the first gas passage portion 16 accumulates up to the position of the liquid level H illustrated in FIG. 14 around the connection part between the end portions of the first and second pipe portions 161 and 162, which is the lower portion of the first gas passage portion 16, during downhill traveling. Accordingly, the first gas passage portion 16 is blocked by the liquid-phase working fluid in the event of continuous uphill-to-downhill switching.

In addition, in the event of continuous uphill-to-downhill switching, most of the liquid-phase working fluid accumulated in the first pipe portion 171A of the second gas passage portion 17A during uphill traveling flows out from the lower end of the first pipe portion 171A to the first gas passage portion 16 without flowing out to the second pipe portion 172A side beyond the upper end of the first pipe portion 171A. Accordingly, in the event of continuous uphill-to-downhill switching, a gas passage portion for causing the gas-phase working fluid to flow from the evaporator 12 toward the condenser 14 is secured in the second gas passage portion 17A.

Further, the gas-phase working fluid that has flowed out to the first pipe portion 161 of the first gas passage portion 16 from each evaporator 12 via each fluid outlet portion 442 during downhill traveling flows into the first pipe portion 171A of the second gas passage portion 17A from the vehicle rear side in the vehicle front-rear direction A3. As a result, the gas-phase working fluid flows into the condenser 14 through the second gas passage portion 17A.

As described above, in the cooling device 1 according to the second embodiment, the first gas passage portion 16 and the second gas passage portion 17A are interconnected via the kick-up portion 170A on the vehicle rear side in the vehicle front-rear direction A3. As a result, it is possible to prevent accumulation of the liquid-phase working fluid in the second gas passage portion 17A, which is concerned at a time of continuous uphill-to-downhill switching. As a result, in the cooling device 1 according to the second embodiment, the gas-phase working fluid can be moved from the evaporator 12 to the condenser 14 through the second gas passage portion 17A in the event of continuous uphill-to-downhill switching.

It should be noted that the liquid-phase working fluid may flow out from the second pipe portion 172A to the third pipe portion 173A side in the event of continuous uphill-to-downhill switching when the liquid level H reaches the position of the second pipe portion 172A of the second gas passage portion 17A during uphill traveling and the liquid-phase working fluid accumulates in the second pipe portion 172A. When the liquid-phase working fluid flows out to the third pipe portion 173A side of the second gas passage portion 17A as described above, the liquid-phase working fluid accumulates around the connection part between end portions of the third and fourth pipe portions 173A and 174A of the second gas passage portion 17A during downhill traveling. Accordingly, the second gas passage portion 17A as well as the first gas passage portion 16 is blocked by the liquid-phase working fluid in the event of continuous uphill-to-downhill switching.

Accordingly, the length of the first pipe portion 171A of the second gas passage portion 17A, which constitutes the kick-up portion 170A, in the vehicle up-down direction A2 may be set to a length at which the liquid level H does not reach the position of the upper-side end portion of the first pipe portion 171A in the vehicle up-down direction A2 at the maximum gradient assumed during uphill traveling such as a rising gradient of 18%.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. In this case, the length of the first pipe portion 171A of the second gas passage portion 17A, which constitutes the kick-up portion 170A, in the vehicle up-down direction A2 may be set to a length at which the liquid level H does not reach the upper-side end portion of the first pipe portion 171A in the vehicle up-down direction A2 at the maximum gradient assumed during downhill traveling. In this manner, it is possible to prevent accumulation of the liquid-phase working fluid in the second gas passage portion 17A, which is concerned at a time of continuous downhill-to-uphill switching, and the gas-phase working fluid can be moved from the evaporator 12 to the condenser 14 through the second gas passage portion 17A. Further, the position of the condenser 14 is not limited to the end portion on the other side, which is opposite to one side where the kick-up portion 170A is positioned in the predetermined direction.

In the cooling device 1 according to the second embodiment, it is possible to suppress the liquid-phase working fluid flowing into and accumulating in the second gas passage portion 17A in a case where the other side relatively moves up and down with respect to one side in the predetermined direction where the kick-up portion 170A is positioned.

### Third Embodiment

Hereinafter, a third embodiment of the cooling device according to the present disclosure will be described. It should be noted that description of parts common to the first and third embodiments will be omitted as appropriate.

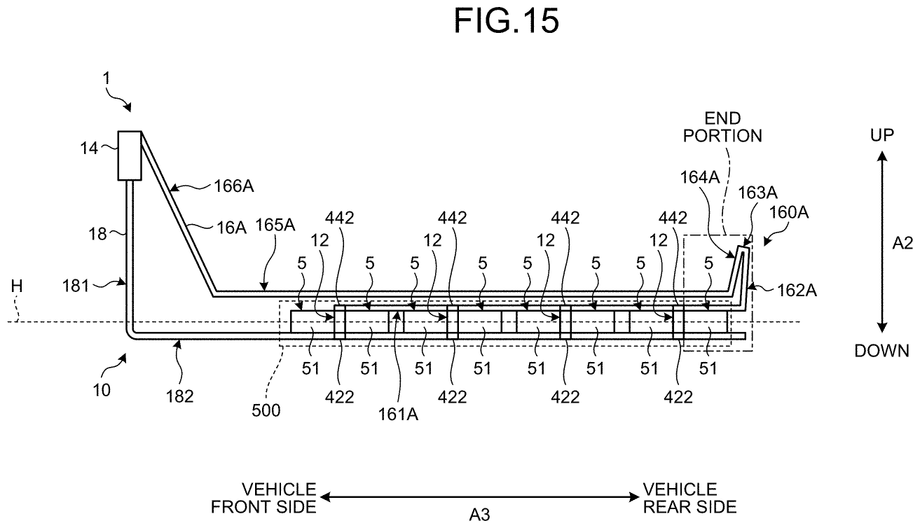

FIG. 15 is a side view illustrating a schematic configuration of the cooling device 1 according to the third embodiment. It should be noted that FIG. 15 illustrates the posture of the cooling device 1 at a time when the vehicle is positioned on a horizontal road surface. In the cooling device 1 illustrated in FIG. 15, the condenser 14 is positioned on the other side in the predetermined direction, that is, the vehicle front side in the vehicle front-rear direction A3.

The cooling device 1 according to the third embodiment includes a gas passage portion 16A as a gas-phase passage portion for guiding the gas-phase working fluid from the evaporator 12 to the condenser 14. The gas passage portion 16A is configured by a first pipe portion 161A, a second pipe portion 162A, a third pipe portion 163A, a fourth pipe portion 164A, a fifth pipe portion 165A, and a sixth pipe portion 166A by means of a piping member or the like.

The first pipe portion 161A extends in the vehicle front-rear direction A3. The respective fluid outlet portions 442 of the four evaporators 12 are connected to the first pipe portion 161A. It should be noted that the end portion of the first pipe portion 161A that is on the vehicle front side in the vehicle front-rear direction A3 is connected to the fluid outlet portion 442 that is positioned in front of the other three fluid outlet portions 442 in the vehicle front-rear direction A3. The second pipe portion 162A stands to the upper side in the vehicle up-down direction A2 with respect to the first pipe portion 161A. The third pipe portion 163A extends in the vehicle front-rear direction A3. The fourth pipe portion 164A is inclined at a falling gradient to the vehicle front side when viewed from the vehicle rear side in the vehicle front-rear direction A3 and extends in the vehicle up-down direction A2. The fifth pipe portion 165A extends in the vehicle front-rear direction A3. The sixth pipe portion 166A is inclined at a rising gradient to the vehicle front side when viewed from the vehicle rear side in the vehicle front-rear direction A3 and extends in the vehicle up-down direction A2.

The lower-side end portion of the second pipe portion 162A in the vehicle up-down direction A2 is connected to the vehicle-rear-side end portion of the first pipe portion 161A in the vehicle front-rear direction A3. The upper-side end portion of the second pipe portion 162A in the vehicle up-down direction A2 is connected to the vehicle-rear-side end portion of the third pipe portion 163A in the vehicle front-rear direction A3. The vehicle-front-side end portion of the third pipe portion 163A in the vehicle front-rear direction A3 is connected to the upper-side end portion of the fourth pipe portion 164A in the vehicle up-down direction A2. The lower-side end portion of the fourth pipe portion 164A in the vehicle up-down direction A2 is connected to the vehicle-rear-side end portion of the fifth pipe portion 165A in the vehicle front-rear direction A3. The vehicle-front-side end portion of the fifth pipe portion 165A in the vehicle front-rear direction A3 is connected to the lower-side end portion of the sixth pipe portion 166A in the vehicle up-down direction A2. The upper-side end portion of the sixth pipe portion 166A in the vehicle up-down direction A2 is connected to the condenser 14. As a result, a gas passage for causing the gas-phase working fluid to flow from the evaporator 12 toward the condenser 14 is formed in the gas passage portion 16A. It should be noted that the parts where the pipe portions are interconnected in the gas passage portion 16A may have an R shape.

In addition, in the cooling device 1 according to the third embodiment, a horn portion 160A is formed by the second pipe portion 162A, the third pipe portion 163A, and the fourth pipe portion 164A of the gas passage portion 16A. The horn portion 160A is formed in the end portion of the gas passage portion 16A that is on the vehicle rear side (one side in the predetermined direction) in the vehicle front-rear direction A3. The horn portion 160A is a rising portion and at least a part of the horn portion 160A rises above the surroundings. Here, in the present embodiment, the end portion of the gas passage portion 16A that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 15. The horn portion 160A has a curved convex shape such that the fourth pipe portion 164A heads downward via the third pipe portion 163A after the second pipe portion 162A rises upward. It should be noted that the curved convex shape includes a so-called bent convex shape.

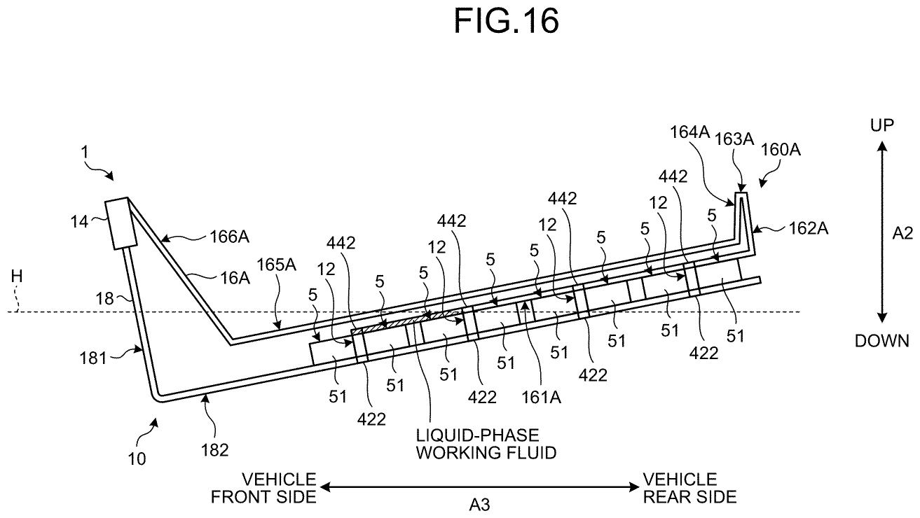

FIG. 16 is a diagram illustrating the posture of the cooling device 1 according to the third embodiment during downhill traveling. As illustrated in FIG. 16, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, during downhill traveling, the liquid-phase working fluid accumulates up to the position of the liquid level H illustrated in FIG. 16 in the first pipe portion 161A of the gas passage portion 16A. Further, the gas-phase working fluid that has flowed out to the first pipe portion 161A of the gas passage portion 16A from each evaporator 12 via each fluid outlet portion 442 flows into the second pipe portion 162A, which constitutes the horn portion 160A, from the vehicle rear side in the vehicle front-rear direction A3. As a result, the gas-phase working fluid flows into the condenser 14 through the gas passage portion 16A.

As described above, in the cooling device 1 according to the third embodiment, the horn portion 160A is provided on the vehicle rear side of the gas passage portion 16A in the vehicle front-rear direction A3. Accordingly, a gas passage for causing the gas-phase working fluid to flow from the evaporator 12 toward the condenser 14 during downhill traveling can be secured in the gas passage portion 16A. As a result, it is possible to suppress accumulation of the liquid-phase working fluid in the gas passage portion 16A from the evaporator 12 to the condenser 14, which is concerned at a time of downhill traveling and to suppress hamper of a movement of the gas-phase working fluid from the evaporator 12 to the condenser 14 through the gas passage portion 16A.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. Further, the position of the condenser 14 is not limited to the end portion on the other side, which is opposite to one side where the horn portion 160A is positioned in the predetermined direction.

### First Modification Example

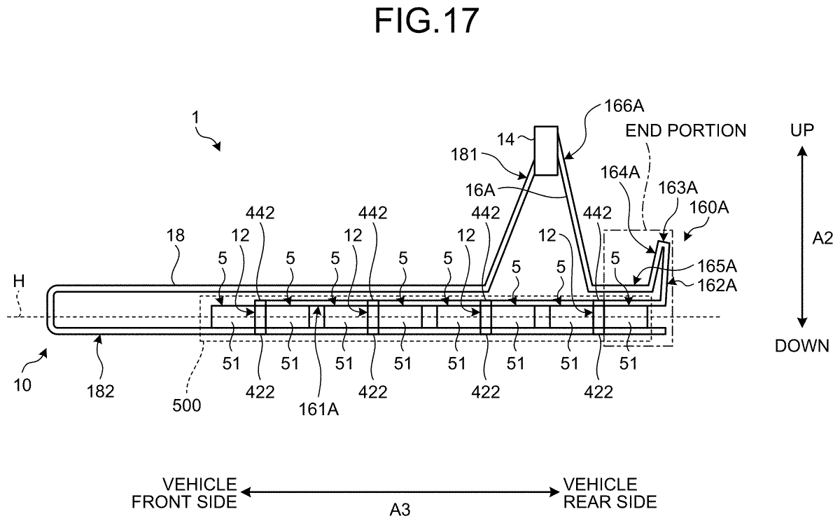

FIG. 17 is a side view illustrating a schematic configuration of the cooling device 1 according to a first modification example of the third embodiment. It should be noted that FIG. 17 illustrates the posture of the cooling device 1 at a time when the vehicle is positioned on a horizontal road surface.

As illustrated in FIG. 17, in the cooling device 1 according to the first modification example, the condenser 14 is positioned near the end portion on the vehicle rear side and in front of the horn portion 160A in the vehicle front-rear direction A3. By the condenser 14 being provided at such a position, the condenser 14 can be disposed in, for example, the trunk room of the vehicle provided on the vehicle rear side in the vehicle front-rear direction A3 in a case where, for example, the engine room of the vehicle is provided on the vehicle front side in the vehicle front-rear direction A3 and a space for disposing the condenser 14 cannot be secured in the engine room.

In addition, in the cooling device 1 according to the first modification example, the horn portion 160A is provided in the end portion of the gas passage portion 16A that is on the vehicle rear side in the vehicle front-rear direction A3. Accordingly, a gas passage for causing the gas-phase working fluid to flow from the evaporator 12 toward the condenser 14 during downhill traveling can be secured in the gas passage portion 16A.

In the cooling device 1 according to the third embodiment and the first modification example, it is possible to suppress the liquid-phase working fluid from accumulating in the gas passage portion 16A and to suppress the gas passage for causing the gas-phase working fluid to flow from the evaporator 12 toward the condenser 14 from being blocked in a case where the other side relatively moves up and down with respect to one side in the predetermined direction where the horn portion 160A is positioned.

### Fourth Embodiment

Hereinafter, a fourth embodiment of the cooling device according to the present disclosure will be described. It should be noted that description of parts common to the first and fourth embodiments will be omitted as appropriate.

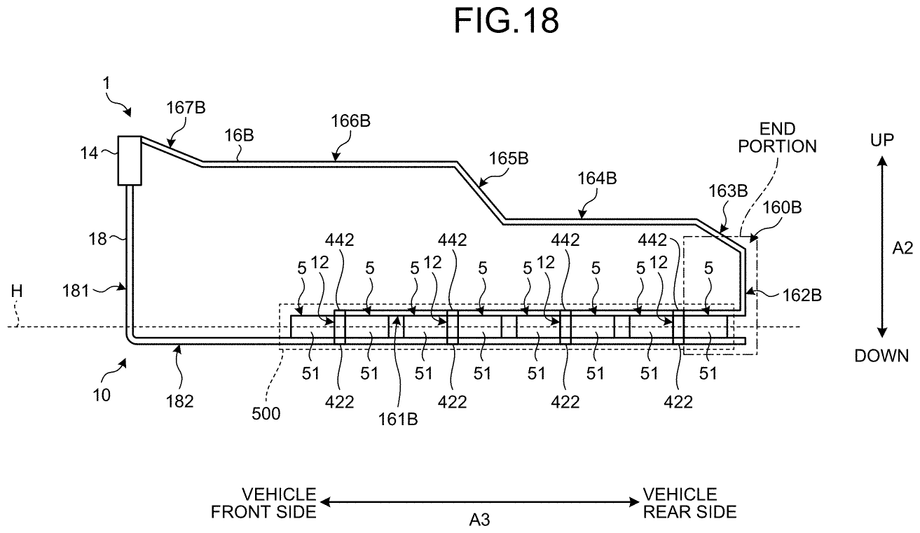

FIG. 18 is a side view illustrating a schematic configuration of the cooling device 1 according to the fourth embodiment. It should be noted that FIG. 18 illustrates the posture of the cooling device 1 at a time when the vehicle is positioned on a horizontal road surface. In the cooling device 1 illustrated in FIG. 18, the condenser 14 is positioned on the other side in the predetermined direction, that is, the vehicle front side in the vehicle front-rear direction A3.

The cooling device 1 according to the fourth embodiment includes a gas passage portion 16B as a gas-phase passage portion for guiding the gas-phase working fluid from the evaporator 12 to the condenser 14. The gas passage portion 16B is configured by a first pipe portion 161B, a second pipe portion 162B, a third pipe portion 163B, a fourth pipe portion 164B, a fifth pipe portion 165B, a sixth pipe portion 166B, and a seventh pipe portion 167B by means of a piping member or the like.

The first pipe portion 161B extends in the vehicle front-rear direction A3. The respective fluid outlet portions 442 of the four evaporators 12 are connected to the first pipe portion 161B. It should be noted that the end portion of the first pipe portion 161B that is on the vehicle front side in the vehicle front-rear direction A3 is connected to the fluid outlet portion 442 that is positioned in front of the other three fluid outlet portions 442 in the vehicle front-rear direction A3. The second pipe portion 162B stands to the upper side in the vehicle up-down direction A2 with respect to the first pipe portion 161B. The third pipe portion 163B is inclined at a rising gradient to the vehicle front side when viewed from the vehicle rear side in the vehicle front-rear direction A3 and extends in the vehicle up-down direction A2. The fourth pipe portion 164B extends in the vehicle front-rear direction A3. The fifth pipe portion 165B is inclined at a rising gradient to the vehicle front side when viewed from the vehicle rear side in the vehicle front-rear direction A3 and extends in the vehicle up-down direction A2. The sixth pipe portion 166B extends in the vehicle front-rear direction A3. The seventh pipe portion 167B is inclined at a rising gradient to the vehicle front side when viewed from the vehicle rear side in the vehicle front-rear direction A3 and extends in the vehicle up-down direction A2.

The lower-side end portion of the second pipe portion 162B in the vehicle up-down direction A2 is connected to the vehicle-rear-side end portion of the first pipe portion 161B in the vehicle front-rear direction A3. The upper-side end portion of the second pipe portion 162B in the vehicle up-down direction A2 is connected to the vehicle-rear-side end portion of the third pipe portion 163B in the vehicle front-rear direction A3. The vehicle-front-side end portion of the third pipe portion 163B in the vehicle front-rear direction A3 is connected to the vehicle-rear-side end portion of the fourth pipe portion 164B in the vehicle front-rear direction A3. The vehicle-front-side end portion of the fourth pipe portion 164B in the vehicle front-rear direction A3 is connected to the lower-side end portion of the fifth pipe portion 165B in the vehicle up-down direction A2. The upper-side end portion of the fifth pipe portion 165B in the vehicle up-down direction A2 is connected to the vehicle-rear-side end portion of the sixth pipe portion 166B in the vehicle front-rear direction A3. The vehicle-front-side end portion of the sixth pipe portion 166B in the vehicle front-rear direction A3 is connected to the lower-side end portion of the seventh pipe portion 167B in the vehicle up-down direction A2. The upper-side end portion of the seventh pipe portion 167B in the vehicle up-down direction A2 is connected to the condenser 14. As a result, a gas passage for causing the gas-phase working fluid to flow from the evaporator 12 toward the condenser 14 is formed in the gas passage portion 16B.

In addition, in the cooling device 1 according to the fourth embodiment, a kick-up portion 160B is formed by the second pipe portion 162B and the third pipe portion 163B of the gas passage portion 16B. The kick-up portion 160B is formed in the end portion of the gas passage portion 16B that is on the vehicle rear side (one side in the predetermined direction) in the vehicle front-rear direction A3. The kick-up portion 160B is a rising portion and at least a part of the kick-up portion 160B rises above the surroundings. Here, in the present embodiment, the end portion of the gas passage portion 16B that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 18. In addition, in the gas passage portion 16B, the fifth pipe portion 165B extends further above the kick-up portion 160B after the fourth pipe portion 164B extends from the kick-up portion 160B to the vehicle front side in the vehicle front-rear direction A3.

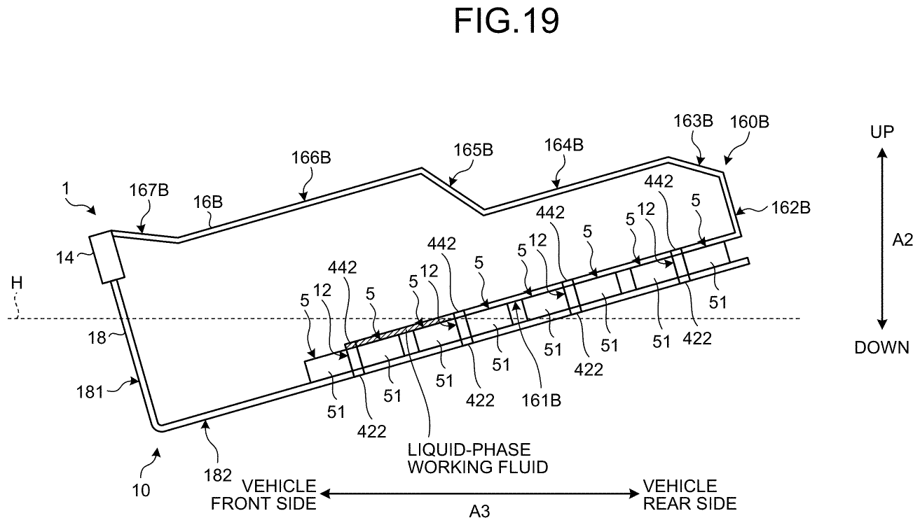

FIG. 19 is a diagram illustrating the posture of the cooling device 1 according to the fourth embodiment during downhill traveling. As illustrated in FIG. 19, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, during downhill traveling, the liquid-phase working fluid accumulates up to the position of the liquid level H illustrated in FIG. 18 in the first pipe portion 161B of the gas passage portion 16B. Further, the gas-phase working fluid that has flowed out to the first pipe portion 161B of the gas passage portion 16B from each evaporator 12 via each fluid outlet portion 442 flows into the second pipe portion 162B, which constitutes the kick-up portion 160B, from the vehicle rear side in the vehicle front-rear direction A3. As a result, the gas-phase working fluid flows into the condenser 14 through the gas passage portion 16B.

As described above, in the cooling device 1 according to the fourth embodiment, the kick-up portion 160B is provided on the vehicle rear side of the gas passage portion 16B in the vehicle front-rear direction A3. Accordingly, a gas passage for causing the gas-phase working fluid to flow from the evaporator 12 toward the condenser 14 during downhill traveling can be secured in the gas passage portion 16B. As a result, it is possible to suppress accumulation of the liquid-phase working fluid in the gas passage portion 16B from the evaporator 12 to the condenser 14, which is concerned at a time of downhill traveling and to prevent a movement of the gas-phase working fluid, from the evaporator 12 to the condenser 14 through the gas passage portion 16B, from becoming difficult.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. Further, the position of the condenser 14 is not limited to the end portion on the other side, which is opposite to one side where the kick-up portion 160B is positioned in the predetermined direction.

In the cooling device 1 according to the fourth embodiment, it is possible to suppress the liquid-phase working fluid from accumulating in the gas passage portion 16B and to suppress the gas passage for causing the gas-phase working fluid to flow from the evaporator 12 toward the condenser 14 from being blocked in a case where the other side relatively moves up and down with respect to one side in the predetermined direction where the kick-up portion 160B is positioned.

### Fifth Embodiment

Hereinafter, a fifth embodiment of the cooling device according to the present disclosure will be described. It should be noted that description of parts common to the first and fifth embodiments will be omitted as appropriate.

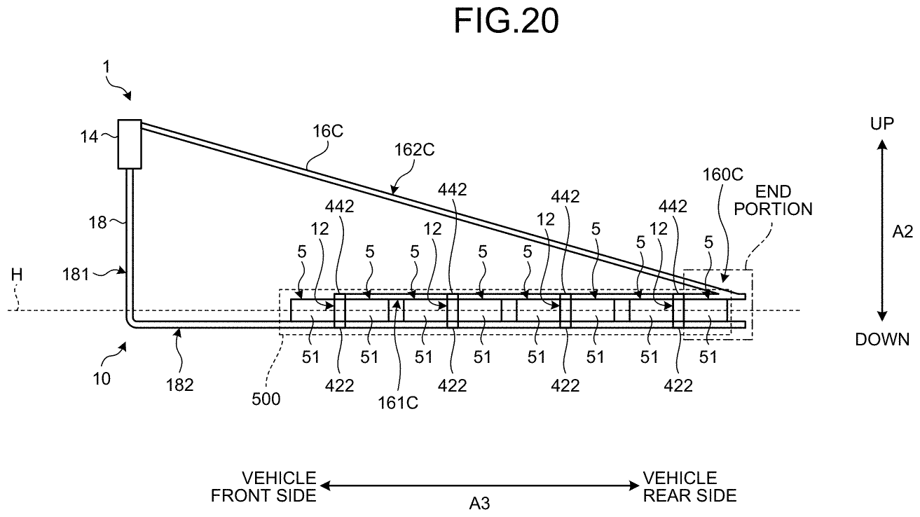

FIG. 20 is a side view illustrating a schematic configuration of the cooling device 1 according to the fifth embodiment. It should be noted that FIG. 20 illustrates the posture of the cooling device 1 at a time when the vehicle is positioned on a horizontal road surface. In the cooling device 1 illustrated in FIG. 20, the condenser 14 is positioned on the other side in the predetermined direction, that is, the vehicle front side in the vehicle front-rear direction A3.

The cooling device 1 according to the fifth embodiment includes a gas passage portion 16C as a gas-phase passage portion for guiding the gas-phase working fluid from the evaporator 12 to the condenser 14. The gas passage portion 16C is configured by a first pipe portion 161C and a second pipe portion 162C by means of a piping member or the like.

The first pipe portion 161C extends in the vehicle front-rear direction A3. The respective fluid outlet portions 442 of the four evaporators 12 are connected to the first pipe portion 161C. It should be noted that the end portion of the first pipe portion 161C that is on the vehicle front side in the vehicle front-rear direction A3 is connected to the fluid outlet portion 442 that is positioned in front of the other three fluid outlet portions 442 in the vehicle front-rear direction A3. The second pipe portion 162C is inclined at a rising gradient to the vehicle front side when viewed from the vehicle rear side in the vehicle front-rear direction A3 and extends in the vehicle up-down direction A2.

The lower-side end portion of the second pipe portion 162C in the vehicle up-down direction A2 is connected to the vehicle-rear-side end portion of the first pipe portion 161C in the vehicle front-rear direction A3. The upper-side end portion of the second pipe portion 162C in the vehicle up-down direction A2 is connected to the condenser 14. As a result, a gas passage for causing the gas-phase working fluid to flow from the evaporator 12 toward the condenser 14 is formed in the gas passage portion 16C.

In addition, in the cooling device 1 according to the fifth embodiment, a rising portion 160C is formed by the second pipe portion 162C of the gas passage portion 16C. The rising portion 160C is formed in the end portion of the gas passage portion 16C that is on the vehicle rear side (one side in the predetermined direction) in the vehicle front-rear direction A3. At least a part of the rising portion 160C rises above the surroundings. Here, in the present embodiment, the end portion of the gas passage portion 16C that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 20.

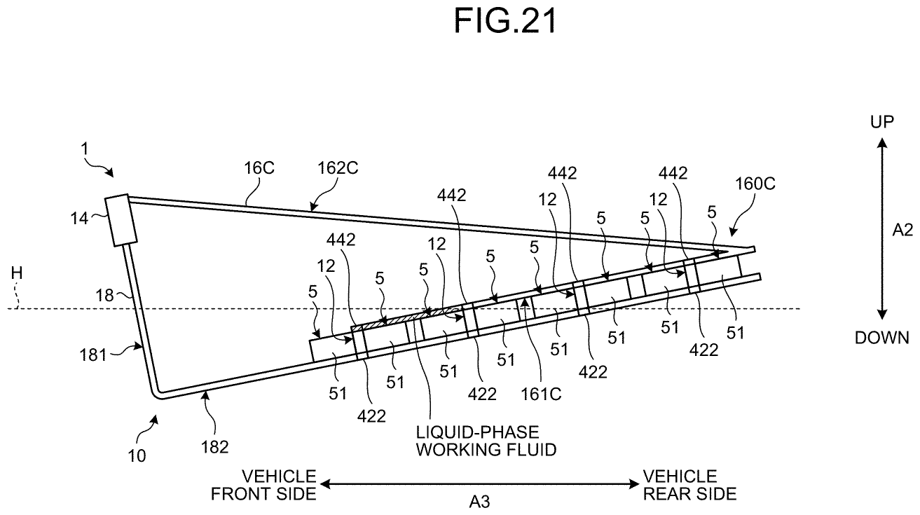

FIG. 21 is a diagram illustrating the posture of the cooling device 1 according to the fifth embodiment during downhill traveling. As illustrated in FIG. 21, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, during downhill traveling, the liquid-phase working fluid accumulates up to the position of the liquid level H illustrated in FIG. 21 in the first pipe portion 161C of the gas passage portion 16C. Further, the gas-phase working fluid that has flowed out to the first pipe portion 161C of the gas passage portion 16C from each evaporator 12 via each fluid outlet portion 442 flows into the second pipe portion 162C, which constitutes the rising portion 160C, from the vehicle rear side in the vehicle front-rear direction A3. As a result, the gas-phase working fluid flows into the condenser 14 through the gas passage portion 16C.

As described above, in the cooling device 1 according to the fifth embodiment, the rising portion 160C is provided on the vehicle rear side of the gas passage portion 16C in the vehicle front-rear direction A3. Accordingly, a gas passage for causing the gas-phase working fluid to flow from the evaporator 12 toward the condenser 14 during downhill traveling can be secured in the gas passage portion 16C. As a result, it is possible to suppress accumulation of the liquid-phase working fluid in the gas passage portion 16C from the evaporator 12 to the condenser 14, which is concerned at a time of downhill traveling and to prevent a movement of the gas-phase working fluid, from the evaporator 12 to the condenser 14 through the gas passage portion 16C, from becoming difficult.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. Further, the position of the condenser 14 is not limited to the end portion on the other side, which is opposite to one side where the rising portion 160C is positioned in the predetermined direction.

In the cooling device 1 according to the fifth embodiment, it is possible to suppress the liquid-phase working fluid from accumulating in the gas passage portion 16C and to suppress the gas passage for causing the gas-phase working fluid to flow from the evaporator 12 toward the condenser 14 from being blocked in a case where the other side relatively moves up and down with respect to one side in the predetermined direction where the rising portion 160C is positioned.

### Sixth Embodiment

Hereinafter, a sixth embodiment of the cooling device according to the present disclosure will be described. It should be noted that description of parts common to the first and sixth embodiments will be omitted as appropriate.

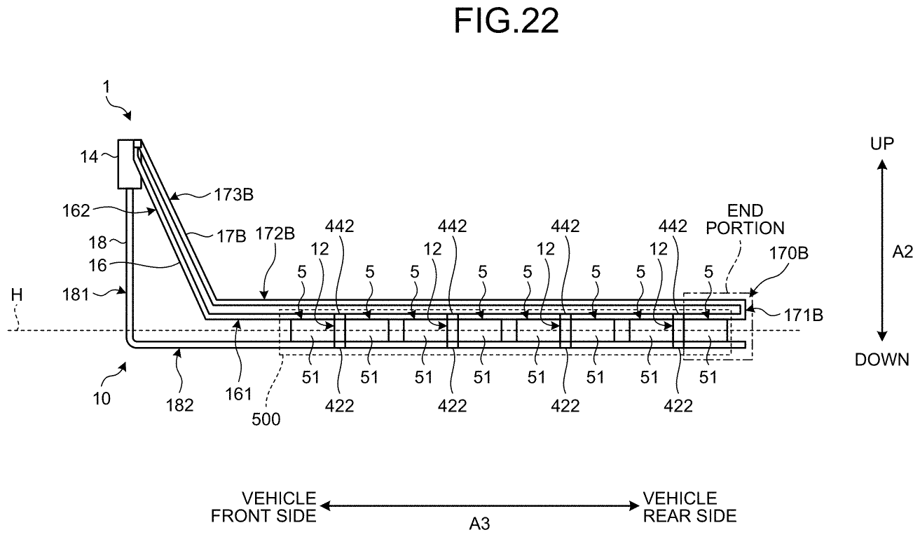

FIG. 22 is a side view illustrating a schematic configuration of the cooling device 1 according to the sixth embodiment. It should be noted that FIG. 22 illustrates the posture of the cooling device 1 at a time when the vehicle is positioned on a horizontal road surface. In the cooling device 1 illustrated in FIG. 22, the condenser 14 is positioned on the other side in the predetermined direction, that is, the vehicle front side in the vehicle front-rear direction A3.

The shape of a second gas passage portion 17B of the cooling device 1 according to the sixth embodiment differs from the shape of the second gas passage portion 17 of the cooling device 1 according to the first embodiment. The second gas passage portion 17B is positioned above the first gas passage portion 16 and guides the gas-phase working fluid evaporated by the evaporator 12 to the condenser 14. The second gas passage portion 17B is configured by a first pipe portion 171B, a second pipe portion 172B, and a third pipe portion 173B by means of a piping member or the like.

The first pipe portion 171B stands to the upper side in the vehicle up-down direction A2 with respect to the first pipe portion 161 of the first gas passage portion 16. The second pipe portion 172B extends in the vehicle front-rear direction A3. The third pipe portion 173B is inclined at a rising gradient to the vehicle front side when viewed from the vehicle rear side in the vehicle front-rear direction A3 and extends in the vehicle up-down direction A2.

The lower-side end portion of the first pipe portion 171B in the vehicle up-down direction A2 is connected to the vehicle-rear-side end portion of the first pipe portion 161 in the vehicle front-rear direction A3 that is in the first gas passage portion 16. The upper-side end portion of the first pipe portion 171B in the vehicle up-down direction A2 is connected to the vehicle-rear-side end portion of the second pipe portion 172B in the vehicle front-rear direction A3. The vehicle-front-side end portion of the second pipe portion 172B in the vehicle front-rear direction A3 is connected to the lower-side end portion of the third pipe portion 173B in the vehicle up-down direction A2. The upper-side end portion of the third pipe portion 173B in the vehicle up-down direction A2 is connected to the condenser 14. As a result, a gas passage for causing the gas-phase working fluid to flow from the evaporator 12 toward the condenser 14 is formed in the second gas passage portion 17B.

In addition, in the cooling device 1 according to the sixth embodiment, a rising portion 170B is formed by the first pipe portion 171B of the second gas passage portion 17B. The rising portion 170B is formed in the end portion on the vehicle rear side (one side in the predetermined direction) in the vehicle front-rear direction A3. At least a part of the rising portion 170B rises above the surroundings. Here, in the present embodiment, the end portion of the second gas passage portion 17B that is on the vehicle rear side (one side in the predetermined direction) in the vehicle front-rear direction A3 is a part on the vehicle rear side (the one side) behind the fluid outlet portion 442 that is closest to the vehicle rear side (the one side) in the vehicle front-rear direction A3 (the predetermined direction), as surrounded by the one-dot chain line in FIG. 22.

In the cooling device 1 according to the sixth embodiment, at least a partial section of the second gas passage portion 17B is disposed above the first gas passage portion 16 in the vehicle up-down direction A2.

Accordingly, the liquid-phase working fluid is less likely to flow in as compared with the first gas passage portion 16. In addition, the second gas passage portion 17B may be configured to pass through a position higher than the battery pack 5 and may be disposed outside the accommodating chamber of the battery pack 5 from the rising portion 170B to the condenser 14 in the interest of space efficiency.

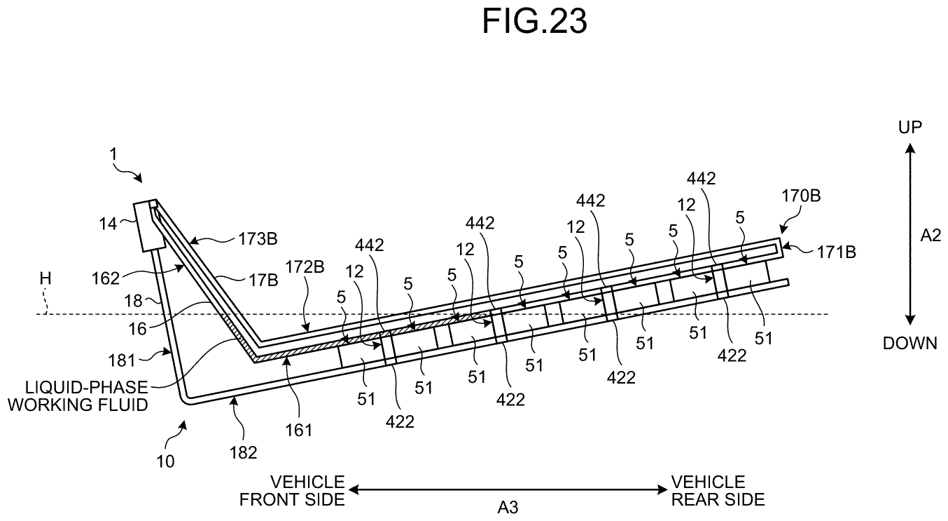

FIG. 23 is a diagram illustrating the posture of the cooling device 1 according to the sixth embodiment during downhill traveling. As illustrated in FIG. 23, the posture of the cooling device 1 during downhill traveling is inclined with respect to the horizontal direction such that the vehicle front side is lower than the vehicle rear side in the vehicle front-rear direction A3. In other words, in the cooling device 1 at a time of downhill traveling, one side and the other side where the condenser 14 is positioned in the predetermined direction relatively move in the vehicle up-down direction A2 such that the other side is lower in position than the one side. When the cooling device 1 is inclined in this manner, a flow of the working fluid leading to liquid-phase working fluid accumulation is generated by gravity or the like on the vehicle front side in the vehicle front-rear direction A3, which is the lower portion of the working fluid circuit 10.

Accordingly, during downhill traveling, the liquid-phase working fluid accumulates up to the position of the liquid level H illustrated in FIG. 23 around the connection part between the end portions of the first and second pipe portions 161 and 162, which is the lower portion of the first gas passage portion 16. Accordingly, the first gas passage portion 16 is blocked by the liquid-phase working fluid during downhill traveling.

Meanwhile, during downhill traveling, a gas passage portion for causing the gas-phase working fluid to flow from the evaporator 12 toward the condenser 14 is secured in the second gas passage portion 17B, as illustrated in FIG. 23. Further, the gas-phase working fluid that has flowed out to the first pipe portion 161 of the first gas passage portion 16 from each evaporator 12 via each fluid outlet portion 442 during downhill traveling flows into the first pipe portion 171B of the second gas passage portion 17B from the vehicle rear side in the vehicle front-rear direction A3 and flows into the condenser 14 through the second pipe portion 172B and the third pipe portion 173B of the second gas passage portion 17B.

As described above, in the cooling device 1 according to the sixth embodiment, the rising portion 170B is provided on the vehicle rear side in the vehicle front-rear direction A3. Accordingly, a gas passage for causing the gas-phase working fluid to flow from the evaporator 12 toward the condenser 14 during downhill traveling can be secured in the second gas passage portion 17B. As a result, it is possible to suppress accumulation of the liquid-phase working fluid in the first gas passage portion 16 from the evaporator 12 to the condenser 14, which is concerned at a time of downhill traveling and to suppress hamper of a movement of the gas-phase working fluid from the evaporator 12 to the condenser 14.

In addition, the present disclosure is not limited to the above-described case of the present embodiment where the cooling device 1 is mounted in the vehicle such that the condenser 14 is positioned in front of the evaporator 12 in the vehicle front-rear direction A3. For example, the cooling device 1 may be mounted in the vehicle such that the condenser 14 is positioned behind the evaporator 12 in the vehicle front-rear direction A3. Further, the position of the condenser 14 is not limited to the end portion on the other side, which is opposite to one side where the rising portion 170B is positioned in the predetermined direction.

In the cooling device 1 according to the sixth embodiment, it is possible to suppress the liquid-phase working fluid from accumulating in the second gas passage portion 17B and to suppress the gas passage for causing the gas-phase working fluid to flow from the evaporator 12 toward the condenser 14 from being blocked in a case where the other side relatively moves up and down with respect to one side where the rising portion 170B is positioned in the predetermined direction.

The cooling device according to the present disclosure has an effect that accumulation of the liquid-phase heat medium in the gas-phase passage portion can be suppressed even in a case where the other side relatively moves up and down with respect to one side in the predetermined direction.

According to an embodiment, the gas-phase passage portion is folded toward the other side in the predetermined direction while rising upward in the end portion on one side in the predetermined direction, and thus it is possible to make it difficult for the liquid-phase heat medium to flow into one side of the gas-phase passage portion in the predetermined direction.

According to an embodiment, it is possible to effectively utilize, for example, the space in the engine room of a vehicle where the cooling device is mounted.

According to an embodiment, it is possible to make it difficult for the liquid-phase heat medium to flow into the other side of the gas-phase passage portion in the predetermined direction and it is possible to reduce the space where the gas-phase passage portion is disposed.

According to an embodiment, it is possible to make it difficult for the liquid-phase heat medium to flow into the other side of the gas-phase passage portion in the predetermined direction.

According to an embodiment, it is possible to increase the degree of freedom of disposition of the gas-phase passage portion.

According to an embodiment, it is difficult for the liquid-phase heat medium to flow into the second gas-phase passage portion provided with the rising portion and the gas-phase heat medium is capable of returning to a condenser.

According to an embodiment, the gas-phase and liquid-phase passage portions and the evaporation unit can be fixed from one direction, and thus it is possible to reduce a work space or improve work efficiency.

According to an embodiment, it is possible to dispose the gas-phase passage portion and the liquid-phase passage portion by effectively utilizing a space, which is for preventing damage to the cooling object when the vehicle undergoes a collision in a direction orthogonal to the predetermined and vertical directions.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cooling device comprising:
an evaporator configured to cool a cooling object by evaporating a heat medium in a liquid phase by a heat exchange between the cooling object and the heat medium;
a condenser, disposed above the evaporator, configured to radiate a heat of the heat medium to an external fluid by condensing the heat medium in a gas phase by a heat exchange between the heat medium and the external fluid;
a gas-phase passage for guiding the gas-phase heat medium from the evaporator to the condenser; and
a liquid-phase passage for guiding the liquid-phase heat medium from the condenser to the evaporator, wherein
the gas-phase passage includes a rising portion on one side of the cooling device in a predetermined direction orthogonal to a vertical direction and at least a part of the rising portion rises above surroundings.

2. The cooling device according to claim 1, wherein the gas-phase passage includes the rising portion in an end portion on one side in the predetermined direction.

3. The cooling device according to claim 1, wherein the condenser is positioned on another side in the predetermined direction.

4. The cooling device according to claim 1, wherein the rising portion has a curved convex shape so as to rise upward and extend downward.

5. The cooling device according to claim 1, wherein the gas-phase passage extends from the rising portion to the another side in the predetermined direction, and further extends above the rising portion.

6. The cooling device according to claim 1, wherein
the cooling object is at least one battery pack including by a plurality of battery cells which are arranged, and
the rising portion is disposed outside an accommodating chamber accommodating the battery pack.

7. The cooling device according to claim 1, further comprising:
a first gas-phase passage as the gas-phase passage; and
a second gas-phase passage, which is disposed so as to pass above the first gas-phase passage, as the gas-phase passage, wherein
the rising portion is formed in the second gas-phase passage.

8. The cooling device according to claim 1, further comprising:
a gas phase-side connection portion configured to interconnect the evaporator and the gas-phase passage; and
a liquid phase-side connection portion configured to interconnect the evaporator and the liquid-phase passage, wherein
the gas phase-side connection portion is divided into an upper portion and a lower portion in an up-down direction, the evaporator is provided in the lower portion of the gas phase-side connection portion, and the gas-phase passage is provided in the upper portion of the gas phase-side connection portion, and
the liquid phase-side connection portion is divided into an upper portion and a lower portion in the up-down direction, the evaporator is provided in the lower portion of the liquid phase-side connection portion, and the liquid-phase passage is provided in the upper portion of the liquid phase-side connection portion.

9. The cooling device according to claim 1, further comprising:
an inflow port into which the liquid-phase heat medium flows and which is provided on one end side of the evaporator in a direction orthogonal to the predetermined and vertical directions; and
an outflow port from which the gas-phase heat medium flows out and which is provided on another end side of the evaporator in the direction orthogonal to the predetermined and vertical directions.
